(19) United States
(12) Patent Application Publication
(10) Pub. No.: US 2014/0221080 A1
(43) Pub. Date: Aug. 7, 2014

(54) ASYNCHRONOUS SYMBOL REPLACEMENT SYSTEM AND METHOD FOR GAME SYSTEMS

(71) Applicant: Quickspin AB, Stockholm (SE)

(72) Inventors: Alexander Cohen, Stockholm (SE); Oscar Berg, Stockholm (SE); Tobias Niva, Stockholm (SE)

(73) Assignee: Quickspin AB, Stockholm (SE)

(21) Appl. No.: 14/171,742

(22) Filed: Feb. 3, 2014

Related U.S. Application Data
(60) Provisional application No. 61/759,733, filed on Feb. 1, 2013.

(51) Int. Cl. G07F 17/32

(52) U.S. Cl. CPC G07F 17/326
USPC 463/21; 463/16; 463/20

(57) ABSTRACT

An asynchronous game action system and method. Some embodiments provide a simulated client-server simulated action game in which displayed action leads to a game outcome. In some simulated reel game embodiments, user initiation of game play causes simulated reel spinning and client issuance of a request to the server provide a game outcome. While the simulated reel spinning takes place, the client awaits receipt of information from the server allowing the client to provide simulated stopped reels showing the game outcome with game outcome symbols displayed on the simulated reels. In some embodiments, one or more symbols can be substituted on the simulated spinning reels while reel spinning takes place or afterward.

### CROSS-REFERENCE TO RELATED APPLICATIONS

This application claims priority through the applicants' provisional application of the same title, filed Feb. 1, 2013, Ser. No. 61/759,733, which is hereby incorporated by reference in its entirety.

### COPYRIGHT NOTICE

This patent document contains material subject to copyright protection. The copyright owner has no objection to the photocopy reproduction of the patent document or the patent disclosure in exactly the form it appears in the Patent and Trademark Office patent file or records, but otherwise reserves all copyright rights.

### FIELD OF TECHNOLOGY

The present application relates to game playing systems and more particularly game systems of the type in which symbols are replaced and updated on simulated moving structure.

### ASPECTS OF THE PRIOR ART

On stand-alone game playing devices, particularly stand-alone wager gaming devices, game outcomes are typically determined on the same machine responsible for displaying game outcomes. These game outcomes are decided synchronously with the game's display, but due to the absence of communication demands, latency is generally not an issue.

In contrast, in game playing systems that use a centralized game logic service residing on a remote server, delays due to transmissions over a LAN or WAN can occur. In the online game environment, and the wager gaming environment in particular, perceivable latency has long been common between the time when a client gaming device sends a message to a game logic server and the time when the client gaming device receives the response from the server containing the information required to initiate and conclude game action on the client device, such on its display, through its audio output, etc.

For example, in the context of an online slot machine game that simulates spinning reels, such perceivable latency often arises between the time when the client game device sends a game initiation message to the game logic server and the time when the server responds with game outcome information, which typically then causes the client device's reel symbols to virtually spin and then stop and display the game outcome symbols in the game outcome locations. In other words, for online slot machine games, often there is a noticeable delay on the client interface between the time a user interaction triggers the beginning of the game, and the time when client receives the game server's response and the reels begin to spin and then stop at the game outcome locations.

While this period of delay can be as short as 100-400 milliseconds in some systems, even that period of time is often perceptible to a game player and reduces the quality of the game experience. In addition, over time these types of repeated delays reduce aggregate game play and can decrease the profitability for game operators. Further, such delay periods often greatly exceed 400 milliseconds, exacerbating the respective problems for game players and game operators respectively.

### BRIEF SUMMARY OF SOME ASPECTS OF THE SPECIFICATION

The applicants believe that they have discovered at least one or more of the problems and issues with prior art systems noted above as well as one or more advantages provided by differing embodiments of the system or system features disclosed in this specification.

Briefly and in general terms, the present disclosure provides for game playing systems that support asynchronous game action initiation while providing for other game activity (e.g., random game activity) for occurrence at the game (e.g., appearance on the game display). In some reel game embodiments for example, this asynchronous system and method can allow one or more reels to begin spinning immediately after a user initiates a game round and subsequently substitute a reel symbol or other indicia on one or more of the reel(s).

In some embodiments, the game logic engine resides on a server system and determines one or more game outcomes—in some instance all game outcomes. The client game system displays a user interface on which users initiate games, but rather than determine the outcomes of these games, the client game system sends a message to a game logic server system requesting the game logic server system to generate and provide the game outcome to the client game system.

In certain of these embodiments, the users can place bets (monetary or otherwise) when initiating games or at other times during game play. The client gaming device then sends information to the game logic server to log the bet. In some embodiments, the server system determines if the bet (if any) is valid, produces a game outcome, and transmits the game outcome to the client game system.

In some embodiments, the server system saves the game outcome. Some instances of this architecture can reduce client game system complexity and cost. Some embodiments allow a failed client game system to more easily and reliably recover to a state consistent with the server system state.

Some reel game embodiments of the symbol replacement system and method include an asynchronous request and response model, initiating one or more reel spin events after the initiation of a game round but prior to the determination of a game outcome or symbol mapping. In some instances, initiation of the reel spin event can occur soon after (for example, less than 500 milliseconds after), and in some applications, virtually immediately and up to immediately after (for example, less than 200 milliseconds after, less than 100 to 10 milliseconds after, and in some cases up to less than 1 millisecond after), a reel spin initiation request is received without regard to game outcome or symbol mapping determinations, such as, for example, random symbol mapping determinations. This can reduce the delay between the reel spin initiation request and the reel spin event up to a period of such short duration that the delay is not perceived by game players. The game play experience can be improved by removal of such delays; and as a result, in some applications, game play providers can procure increased game play, patronage, and revenue (in revenue generating applications).

In some reel game instances, one or more reel symbols are replaced during a spin event. In certain of these instances, temporary symbols are replaced by symbols from an updated set of reels and associated reel symbols, including symbols used in the game outcome. In some applications, this update during the spin event can increase the excitement and anticipation associated with such games, as the player can see the winning symbols on the spinning reel prior to displaying the game outcome. In the case of some virtual spinning reel systems, this can improve the degree of realism by showing the reels and reel symbols used as part of the game outcome determination. In certain embodiments, mapping of multiple placeholders randomly and updating the reels with associated graphic representation can provide game designers with a mechanism to balance the feel of the game play, thus making the game more entertaining to players, and therefore more valuable to operators.

Some systems implement a client-server architecture where a server-based service can serve more than one client gaming device. The asynchronous nature of the transactions allows multiple client devices to send concurrent game outcome requests to the server-based service without the load of such requests impacting the game experience by delaying local events (such as reel spin in the case of a reel game and any associated sound). Processing activities can be ordered and balanced at the discretion of the server system, enabling the server system to optimize performance for the game system generally. In some systems, these approaches can improve system performance and overall scalability.

In certain instances, a temporary mapping is used to populate the local event. In the case of some reel game embodiments, the set of symbols used to populate the reel can be determined from a mapping of logical identifiers to graphical symbols, where the logical identifiers can include one or more identifiers that lack a fixed graphical symbol mapping. These identifiers, lacking a fixed graphical symbol mapping, can serve as placeholders for randomization of symbols determined by a mapping of placeholders to graphical symbols based on updated mappings. In certain instances, the placeholders can be grouped on reels in a manner promoting excitement and a perception of increased probability of obtaining a winning outcome, even where such probabilities are strictly managed by the gaming system. Some embodiments of this approach can create a perception of game flow continuity between successive spins resulting from the smooth mid-spin transition between symbols most recently observed and the new set of symbols used in the current game outcome.

In some embodiments, the asynchronous symbol replacement system and method can implement more than one distinct placeholder. Each distinct placeholder can correspond to an explicit placeholder mapping that may differ from other placeholder mappings. In some reel game examples in which multiple symbols can be repopulated on the reel definitions in differing spins, a combination of symbols can appear with very high frequency or in large sequential blocks on the reels for one spin, and then the next spin can have a different combination of symbols. In some applications, this can increase the perceived variations in the system by leveraging the existing placeholder model without compromising the perception of increased probability of obtaining a winning outcome.

Further, in some instances, such repopulation of multiple symbols on the reel definitions (which can be random repopulation if desired) can allow a game designer to (i) manipulate the probability of symbols such that some can appear with high frequency one spin and have a high likelihood of payout for that spin, then (ii) have a lower likelihood of payout on the following spin, balancing the payout percentage for the game overall. In some embodiments, this dynamic can provide a more easily understandable game for players, such as by providing an immediate understanding of what qualifies as a winning outcome in the game.

It is to be understood that this Brief Summary of Some Aspects of the Specification recites only some aspects of the present disclosure. There are other novel and advantageous aspects. They will become apparent as this specification proceeds. Thus, the scope of the disclosure is to be determined by the claims as issued and not by whether the subject matter addresses an issue identified in the Aspects section above or includes or provides a feature set forth in this Brief Summary.

### BRIEF DESCRIPTION OF THE DRAWINGS

The applicant's preferred and other drawings are disclosed in association with the accompanying Figures. In the Figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a schematic block diagram of one embodiment of a network configuration for a plurality of gaming devices disclosed herein.

FIG. 2 is a schematic block diagram of one embodiment of an electronic configuration for one or more of the gaming devices of FIG. 1.

FIG. 3 is a block diagram of the gaming devices of FIG. 1.

FIG. 4 is a flow chart of a computer-implemented process of synchronous symbol replacement in the client/server gaming architecture of FIG. 1.

FIG. 5 is a flow chart of a client-side computer-implemented process of synchronous symbol replacement in a client/server gaming architecture of FIG. 1.

FIG. 6 is a flow chart of a computer-implemented process of asynchronous symbol replacement in the client/server computing architecture of FIG. 1.

FIG. 7 is a flow chart of a client-side computer-implemented process of asynchronous symbol replacement in the client/server computing architecture of FIG. 1.

FIG. 8A is a random number generation flow diagram for the computer-implemented process of asynchronous symbol replacement in FIG. 6.

FIG. 8B is a random symbol mapping flow diagram for the computer-implemented process of asynchronous symbol replacement in FIG. 6.

FIG. 9 is a game outcome evaluation flow diagram for the computer-implemented process of asynchronous symbol replacement in FIG. 6.

FIG. 10 is a flow chart of a computer-implemented process of state restoration in the client/server gaming system of FIG. 1.

FIG. 11A is a diagram of various elements of a randomization process for determining random symbols, reel modification, and reel display in the computer-implemented process of asynchronous symbol replacement of FIG. 6 and FIG. 7.

FIG. 11B is a mapping of logical symbols to graphical symbols as part of a randomization process for determining random symbols, reel modification, and reel display in the computer-implemented process of asynchronous symbol replacement of FIG. 6 and FIG. 7.

FIG. 11C is an example of a reel after logical symbol replacement occurs as part of a randomization process for determining random symbols, reel modification, and reel display in the computer-implemented process of asynchronous symbol replacement of FIG. 6 and FIG. 7.

FIG. 11D are placeholder value tables for determining random symbols, reel modification, and reel display in the computer-implemented process of asynchronous symbol replacement of FIG. 6 and FIG. 7.

FIG. 12 is a diagram of various elements of a first additional randomization process for determining random symbols, reel modification, and reel display in the computer-implemented process of asynchronous symbol replacement of FIG. 6 and FIG. 7.

FIG. 13 is a diagram of various elements of a second additional randomization process for determining the random symbols, reel modification, and display of pre-defined reel configuration overlays in the computer-implemented process of asynchronous symbol replacement of FIG. 6 and FIG. 7.

FIG. 14 is a flowchart of a method for asynchronous symbol replacement in a game play system.

FIG. 15 is a flowchart of another method for asynchronous symbol replacement in a game play system.

FIG. 16 is a flowchart of another method for asynchronous symbol replacement in a game play system.

FIG. 17 is a flowchart of another method for asynchronous symbol replacement in a game play system.

FIG. 18 is a flowchart of another method for asynchronous symbol replacement in a game play system.

FIG. 19 is a screen capture of the game client display of FIG. 2 using virtual reels after the completion of a spin event.

FIG. 20 is a screen capture of the client game client display of FIG. 2 after a new spin event has been initiated and prior to receipt of a game outcome message and symbol replacement mapping.

FIG. 21 is a screen capture of the game client display of FIG. 2 after a new spin event has been initiated using temporary reel symbols prior to receipt of a game outcome message and symbol replacement mapping.

FIG. 22 is a screen capture of the game client display of FIG. 2 after a new spin event has been initiated with updated symbols after receipt of a game outcome message and symbol replacement mapping.

FIG. 23 is a screen capture of the game client display of FIG. 2 after a new spin event has been initiated with updated symbols after receipt of a game outcome message and symbol replacement mapping.

FIG. 24 is a screen capture of the client display of FIG. 2 after a new spin event has been initiated with updated symbols after receipt of a game outcome message and symbol replacement mapping, and after at least some of the reels are no longer spinning

FIG. 25 is an excerpt of a reel strip configuration in XML format for the SymbolSet element.

FIG. 26 is an excerpt of a reel strip configuration in XML format for the ReelGrid elements.

FIG. 27 is an excerpt of a reel strip configuration in XML format for the Reel elements.

FIG. 28 is an excerpt of a reel strip configuration in XML format for the WinCombinationSet elements.

FIG. 29 is an excerpt of a reel strip configuration in XML format for the EvaluationsPattern elements.

FIG. 30 is an excerpt of a reel strip configuration in XML format for the WeightedLists elements.

FIG. 31 is an excerpt of a game outcome response in XML format for the GameState elements and the ReelGridSpinStops elements.

FIG. 32 is an excerpt of a game outcome response in XML format for the GameEvalResult elements, the ReelGridEvalResult elements, the PatternEvalResult elements, and the Balance element.

### DETAILED DESCRIPTION OF THE DRAWINGS

In some embodiments of the game-providing system, a client system is communicatively coupled to a server system. Software (which may be embodied in firmware) executes on both the client game system such as, for example, a dedicated gaming machine, mobile device, personal computer, or other computing device, and a game server system. These game-providing systems may support wagering of all types, such as one or more of real-money wagers, virtual wagers, or other types of wagers; but these systems also may provide one or more games with no wagering capability.

In a reel game embodiment of a client-server game system, during a reel spin event, the client game system replaces one or more of the symbols on one or more reel strips with other symbols. In some embodiments, the symbols replaced are not associated with any fixed logical identifiers and serve as temporary placeholders to be replaced by a set of symbols associated with fixed logical identifiers. In some instances, the client game system does not know which symbol replaces the placeholder at the time the spin event is initiated and displays temporary symbols on the reels prior to receiving game outcome and symbol replacement mapping information from the game server system. When the game client receives the new mapping from the game server system, it updates the display while the reels are in a spinning state, and subsequently stops the reels, displaying the full game outcome.

In some embodiments, the client game system includes software providing a user interface that, for example, solicits wagers, initiates games, and accepts spin event requests. The software can also serve as part of the communication system sending and receiving messages to and from one or more game servers. The client gaming system can have access to local information relating to the arrangement of reel strips, payouts, and graphics. In certain of these embodiments, this information is hard-coded into the source code residing on the game client. In an alternate embodiment, the information is loaded at the game client dynamically upon initialization. In certain instances, one or more game servers perform the logical analysis determining the outcome of a game. In an alternate embodiment, the client gaming system performs the logical analysis.

In some embodiments, a game server, such as, for example, an HTTP server, includes gaming software and hosts the gaming logic engine. The server can have knowledge of, or access to, individual player accounts and, in gaming applications, balances in which wagers can be debited and winnings can be credited. When a request for a game outcome is received and validated, the server runs the game logic engine to produce an outcome for the game round. In some embodiments, the game server logs the game outcome after it is generated. The server can also modify relevant information, such as in gaming applications for example, updating balances with winnings and/or virtual winnings In some instances, the game server logs sufficient information relating to the game outcome to enable client game instance state restoration in situations where such restoration is desired including, for example, if a communication failure between the server and the client results in a situation where the game outcome was applied to the user's account, but was not displayed on the client game system.

In some embodiments, the client game system can include a thin client viewer such as, for example, an Internet browser that downloads client game software. In other embodiments, the client game system uses an instant-download format such as a Unity program viewable through the Unity web player, a Java applet, a Flash player, or an HTML5 program implemented on a server stack implementing, for example, HTML, JavaScript and CSS. In yet another embodiment, the client game software can be run directly on the client game system, such as, for example, as an executable binary or a an app on a mobile device. The client game system implementation can utilize one or more programming languages including, for example, Action Script, Java, Objective-C, and/or HTML5+JavaScript+CSS.

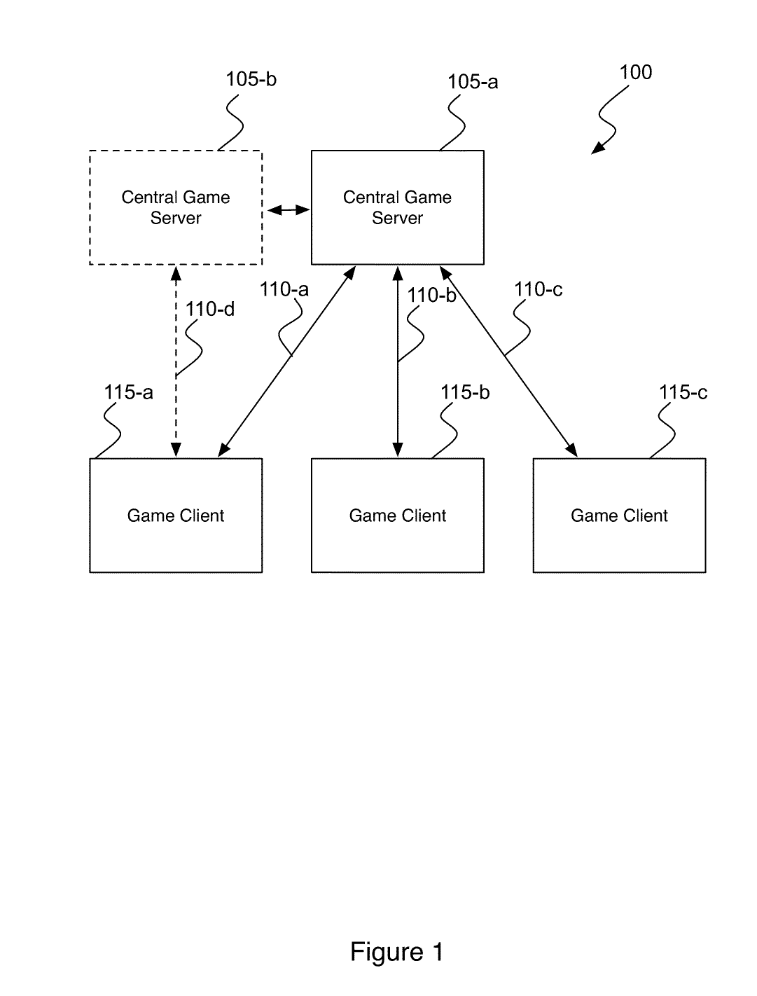

Referring now to FIG. 1, in some embodiments of the game playing system 100, one or more of the game clients 115 is connected to a central game server 105 over a data network 110-a or a remote communication link 110-b with some or all of the functions of each game client 115 provided at the central game server 105. The data network or communication link can be wired connection 110-a or wireless connection 110-b, with both types of communication methods combined in a single distributed gaming system 100. In some embodiments, the game server resides on single hardware device or virtual instance, combining at least a CPU, memory, and server framework such as, for example, Glassfish, JBoss, Jetty, Tomcat, ASP, or PHP. In another embodiment, there are multiple game servers enabling application load balancing. The server software can be implemented in any server programming language, including for example, Java, C#, and C++.

In certain instances, the game outcome information is determined by the central game server 105 and provided to the game clients 115 over the communication network 110. In this example, multiple game clients 115 are in communication with the central game server 105. Upon receiving a request to initiate a game, the game client 115 provides game initiation information to the central game server 105, which information can include a game outcome request message. In some embodiments, the central game server is a progressive controller or another gaming machine in the gaming system.

Upon receiving the game initiation information, the central game server 105 generates a game outcome, including the generation of a symbol replacement mapping based on one or more of a random number generation algorithm, a weighting algorithm, or probability determinations. In some instances, the central server stores and executes program code. In other instances, server functions are distributed across multiple game servers 105-a, 105-b. Game servers can include one or more server devices, virtual server instances, or both.

The central game server communicates the generated game outcome to the initiating game client. The game client receives the generated game outcome, processes the received game outcome message, and updates the display screen, touch screen, or other interfaces with data and media in accordance with the received game outcome information. In an alternative embodiment, how the generated game outcome is to be presented or displayed to the player, such as, for example a slot machine reel symbol combination or a hand of cards, is also determined by the central game server 105 and communicated to the initiated game client 115.

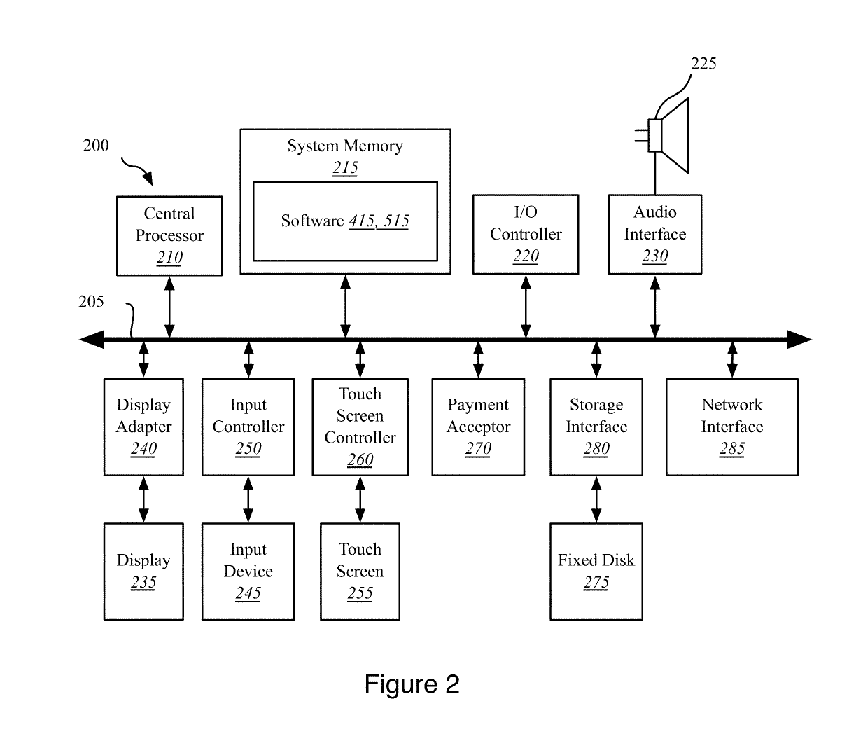

Referring now to FIG. 2, game device 200 is an example of a game client 115, central game server 105, or both (e.g., see FIG. 1). In one configuration, game device 200 includes a bus 205 which interconnects major subsystems of the game server 105 and game client 115, such as a central processor 210, a system memory 215 (typically RAM, but which may also include ROM, flash RAM, or the like), an input/output controller 220, an external audio device, such as a speaker system 225 via an audio output interface 230, an external device, such as a display screen 235 via display adapter 240, an input device 245 (e.g., remote control device interfaced with an input controller 250), a touch-screen device 255 (coupled with a touch-screen controller 270), a payment acceptor device 270, and a storage interface 280 to a data store 275. Also included is a network interface 285 which can be coupled directly to bus 205. In some embodiments, the touch-screen 255 can include a touch-sensitive display overlay allowing player interaction with the images on the display. The touch-screen and the touch-screen controller can be connected to the display adapter 240. A player can make decisions and input signals into the game device 200 by touching the touch-screen at the appropriate places. The game device 200 may further include a plurality of communication ports for enabling communication of the processor with external peripherals, such as external video sources, expansion buses, game or other displays, an SCSI port or a key pad. The display device of the gaming device can be configured to display at least one of game or other suitable images, symbols and indicia such as any visual representation or exhibition of the movement of objects such as mechanical, virtual or video reels and wheels, dynamic lighting, video images, images of people, characters, places, things and faces of cards, tournament advertisements and the like.

In some implementations, the game device includes at least one payment acceptor 270 in communication with the central processor 210. The payment acceptor can include a coin slot and a payment, note or bill acceptor, where the player inserts money, coins or tokens. The player can place coins in the coin slot or paper money, ticket or voucher into the payment, note or bill acceptor. In other embodiments, devices such as readers or validators for credit cards, debit cards or credit slips may accept payment. In some instances, a player can insert an identification card into a card reader of the gaming device. In certain of these instances, the identification card is a smart card having a programmed microchip or a magnetic strip coded with a player's identification, credit totals and other relevant information. In some implementations, money can be transferred to a gaming device through electronic funds transfer. When a player funds the gaming device, the processor determines the amount of funds entered and displays the corresponding amount on the credit or other suitable display as described above. In other implementations, the payment acceptor can be a keypad or other input interface coupled to at least one of a cashless gaming credit system, credit account system, or wager account system.

Bus 205 allows data communication between central processor 210 and system memory 215, which may include read-only memory (ROM) or flash memory (neither shown), and random access memory (RAM) (not shown), as previously noted. The RAM is generally the main memory into which the operating system and game application programs are loaded. The ROM or flash memory may contain, among other code, the Basic Input-Output system (BIOS), which controls basic hardware operation such as the interaction with peripheral components or devices.

Storage interface 280, as with the other storage interfaces of gaming device 200, can connect to a standard computer readable medium for storage and/or retrieval of information, such as a fixed disk drive. Fixed disk 275 can be a part of gaming device 200 or can be separate and accessed through other interface systems. Network interface 285 may provide a direct connection to a remote server via a direct network link. Network interface 285 may provide such connection using wireless techniques, including WiFi, digital cellular telephone connection, digital satellite data connection, or the like.

Many other devices or subsystems (not shown) may be connected in a similar manner (e.g., a display, computing device, keypad, camera, authentication device, and so on). Conversely, all of the devices shown in FIG. 2 need not be present to practice the present systems and methods. The devices and subsystems therefore may be interconnected in different ways from that shown in FIG. 2. The aspect of some operations of a system such as that shown in FIG. 2 are readily known in the art and are not discussed in detail in this application. Computer instructions to implement the present disclosure may be stored in a non-transitory computer-readable medium such as one or more of system memory 215 or data store 275.

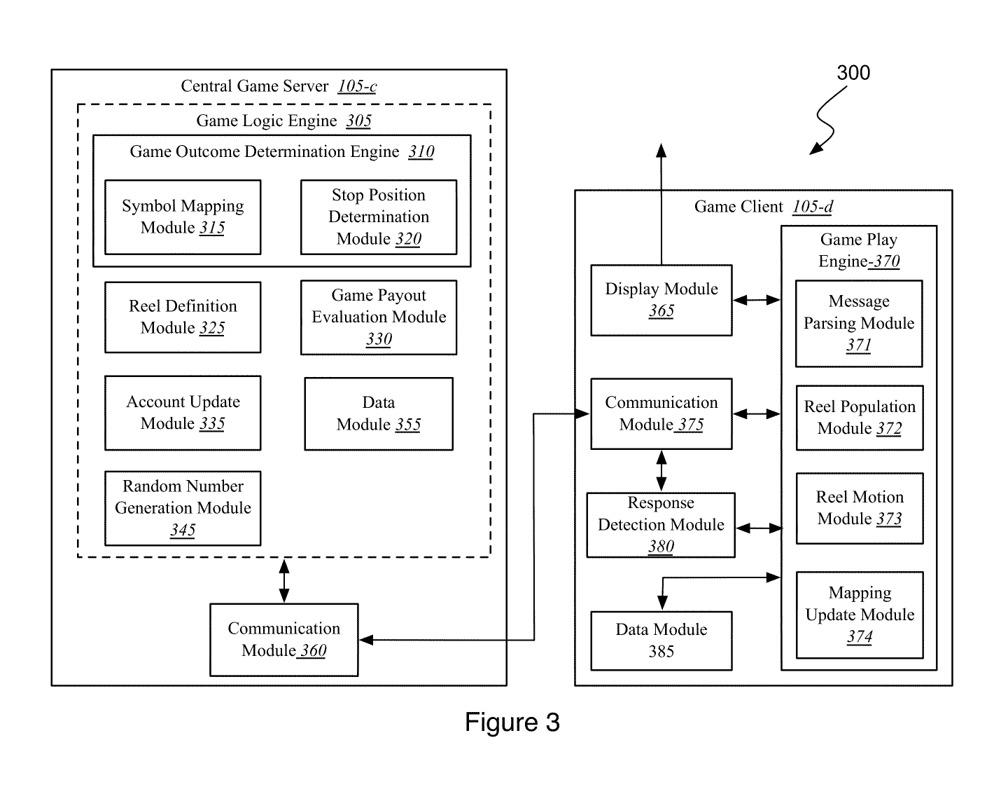

Referring now to FIG. 3, in some embodiments, a game logic engine of the central game server 105-c includes a game outcome determination engine 310, a reel definition module 325, a game payout evaluation module 330, an account update module 335, a random number generation module 345, a state management module 350, a data module 355, and a communication module 360. The game outcome determination engine 310 determines the outcome of a game, including a symbol mapping module 315 for generating symbol replacement mapping determinations, and stop position determination module 320 for generating a stop position for one or more reels. The game outcome determination engine 310 can also prepare game outcome response messages and pass these messages to the communication module 360 for transmission to the game client 115-d.

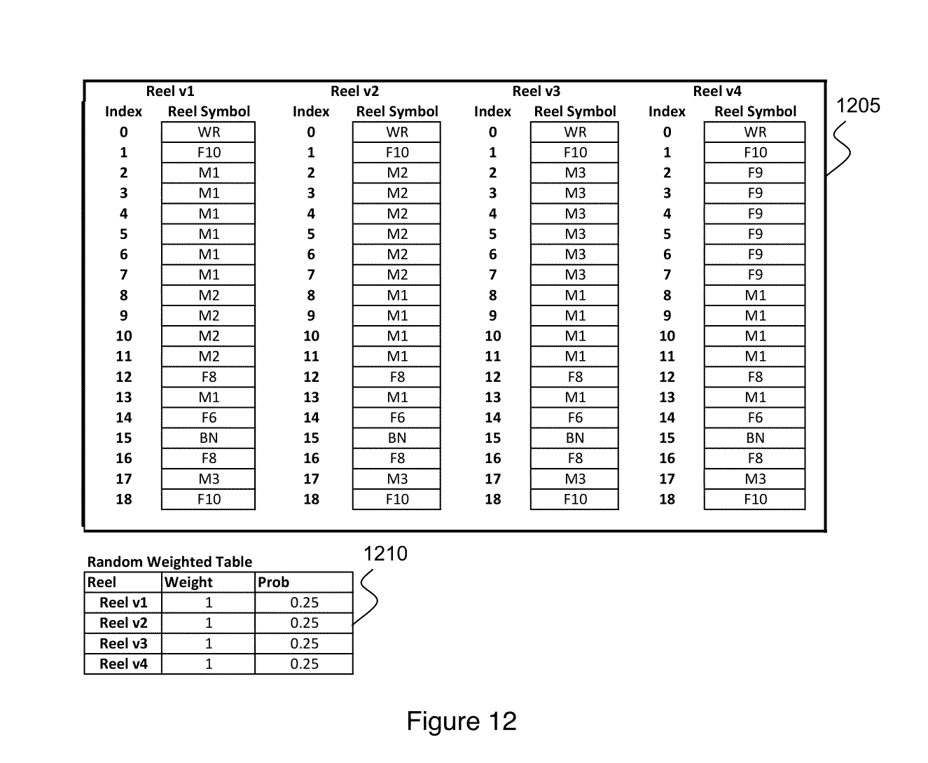

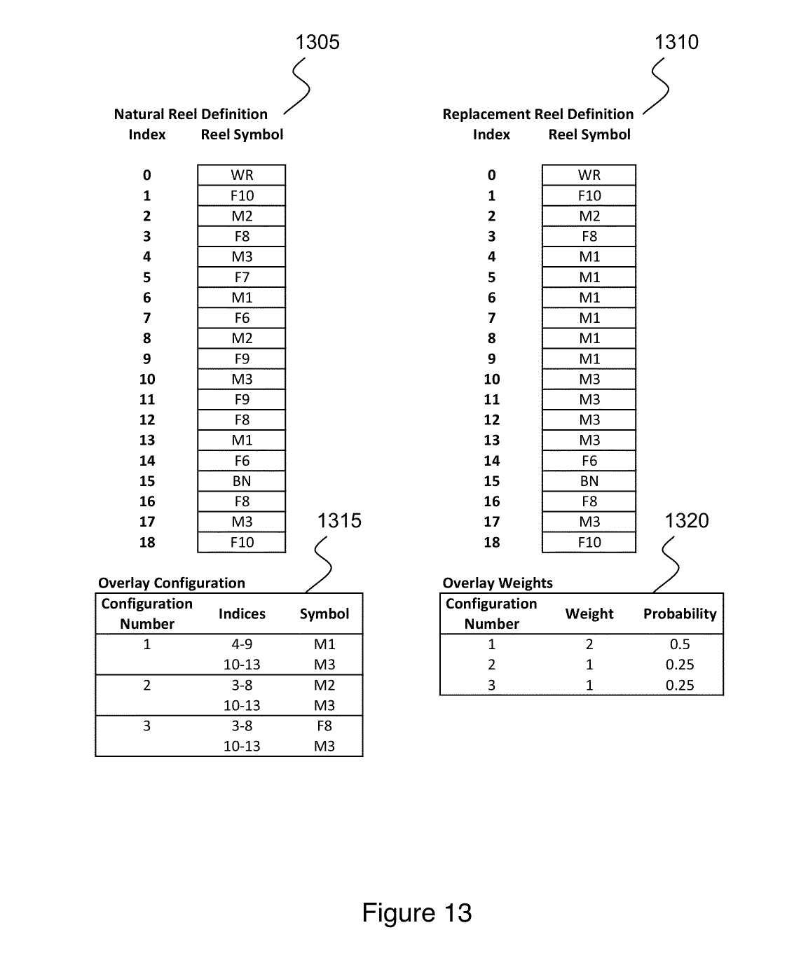

In certain instances, reel definition module 325 generates reel definitions, that can be based on symbol replacement mappings generated by the symbol mapping module 315. In some embodiments, the reel definition module 325 supplies reel definitions to the symbol mapping module 315 for the random selection of reels (e.g., see FIG. 12), the selection of reel overlay portions (e.g., see FIG. 13), or both. The reel definition module 325 can also manage and provide other modules with access to pre-defined reels, which can be stored in a data store accessible through data module 355.

A game payout evaluation module 330 evaluates the paylines/scatter areas for one or more reel grids, and passes to the game outcome determination engine 310 summary information including, for example, the win outcome for each payline, the reel grid coordinates of the win, the name of the winning combination, and/or the payout. This summary information can be included in the game outcome response message returned to the game client initiating the game. This summary information can also be passed to the account update module 335. The account update module 335 then updates the appropriate user account and/or related credit or wager accounts.

A random number generation module 345 performs random number generation based on one or more random number generation algorithms. In some instances, random number generation can be used in the selection process for symbol replacement, final stop positions, and the like, and can incorporate probability weighting based on pre-defined weighting factors.

In some implementations, a communication module 360 supports transmitting and receiving messages to and from game clients 115-c, game servers 105, or both. The communication module may access and use routing tables and routing lists stored in data store accessible by a data module 355 for network data transmissions. An optional Internet gateway component may provide communication support for communicating with remote devices, service provider devices, web services (not shown), and the like.

Still referring to FIG. 3, in some embodiments, a game client 115-c includes a game play engine 370, a display module 365, a communication module 350, a response detection module 380, and a data module 385. In some instances, a communication module 375 supports transmitting and receiving messages to and from the central game server 105-d. The communication module may access and use routing tables and routing lists stored in data store accessible by a data module 385 for network data transmissions. An optional Internet gateway component may provide communication support for communicating with remote devices, service provider devices, web services (not shown), and the like.

A response detection module 380 monitors communications with the central game server to determine when a game outcome response message is received. In some instances, the response detection module 380 is implemented as a polling service that queries, at pre-defined time intervals, either a particular location where the message is stored or a service that responds with an acknowledgment when a message has been received. In certain cases, the response detection module 380 is implemented as a listener that remains in a wait state until another module sends an unsolicited message to the response detection module 380 indicating a game outcome response message has been received. Upon receipt, the response detection module 380 messages the game play engine initiating the symbol replacement process.

In certain implementations, game play engine 370 includes a message parsing module 371, a reel population module 372, a reel motion module 373, and a mapping update module 374. When a message is received from the central game server 105-d, such as a game outcome response message, the parsing module will parse the message such that the game outcome can be processed and the appropriate player interaction can occur. In some instances, XML messages are initially parsed by a standard XML parser, such as the MSXML parser from Microsoft. The game play engine 370 uses the values obtained to process the game outcome. For example, the mapping update module 374 can use the symbol replacement mapping information to determine a symbol replacement plan, leading to reel population model repopulating one or more reel symbols based on the updated symbol mapping.

In some embodiments, the reel motion module 373 directs the display module 365 to display reels in specific position based, at least in part, on whether the game is executing a spin event. During the occurrence of a spin event, the reel motion module 373 performs calculations indicating when the reels should be painted and in what relative position based on the determined speed degradation in combination with the symbol order on the reel. In some instances, the reel motion module 373 functions independently of the other modules in the game play engine 370.

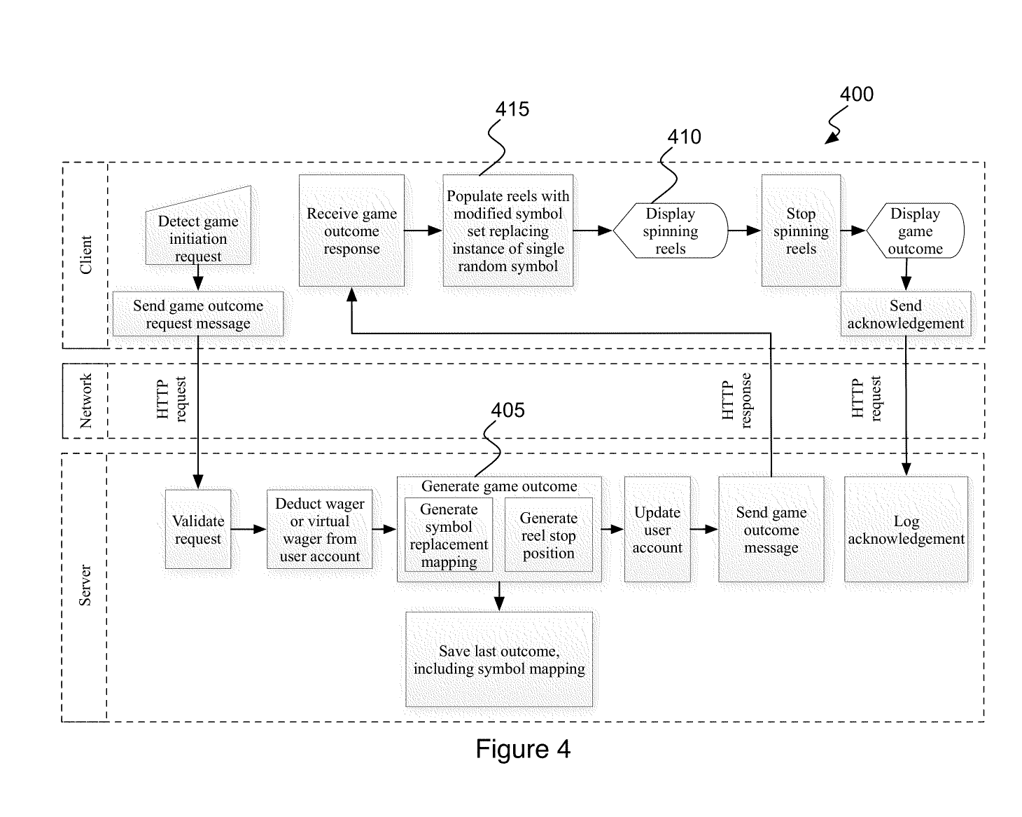

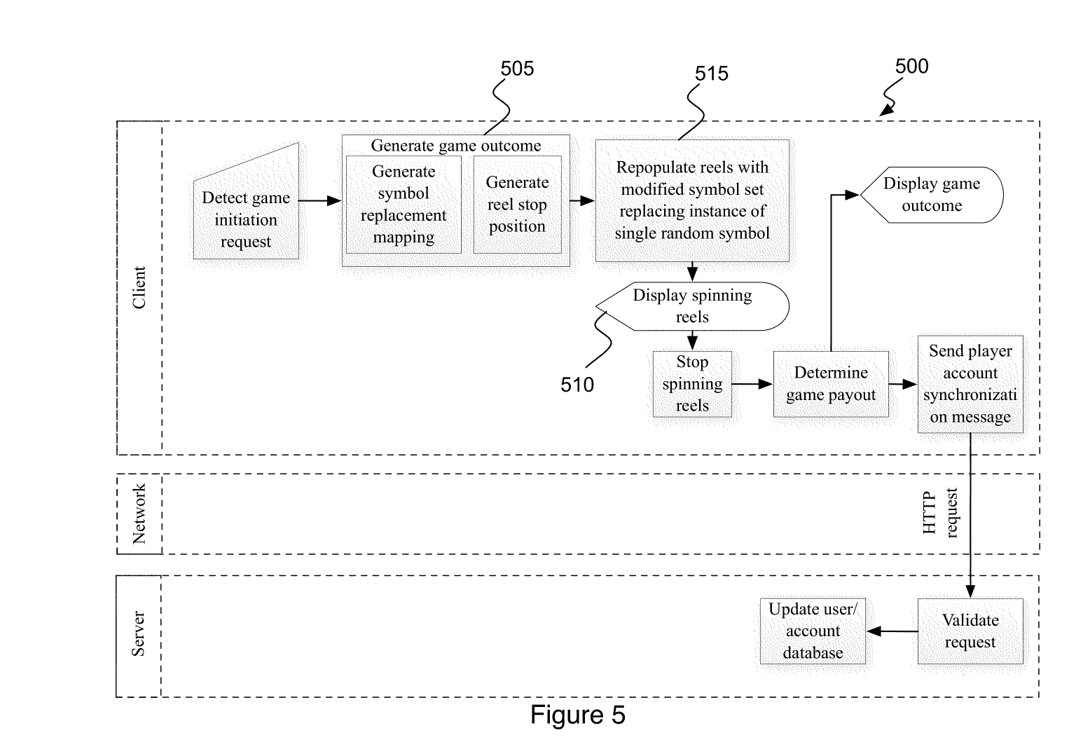

As explained above, synchronous symbol replacement implementations tend to result in delays due, in part, to the fact that they are serial in their method of display. Referring now to FIG. 4 and FIG. 5, a server-based synchronous request and response model 400 and a client-based synchronous request and response model 500 are shown. In both implementations, the initial display of spinning reels 410, 510 does not occur until the final game outcome, including replacement symbol mapping, is generated or received 405, 505, and not until at least a portion of the final reel repopulation is complete 415, 515. Everything that occurs downstream of the generation of the game outcome 405, 505 is susceptible to a delay, and in particular, the initiation of the spin event in a spinning reel game for example.

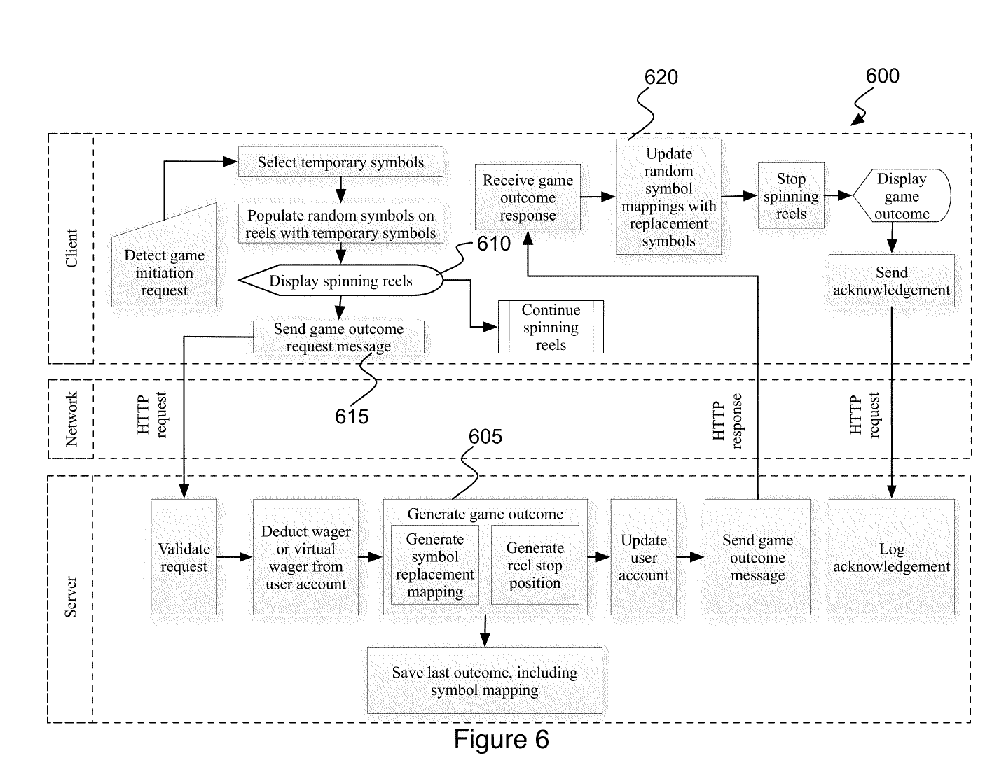

Referring now to FIG. 6, in some embodiments, the game server implements an asynchronous request/response server flow, using a technique such as HTTP long-pulling or streaming. In certain of these embodiments, a socket connection is opened and the connection remains alive for an extended duration. Responses from the server are pushed over an existing connection, reducing the cumulative response time by eliminating the need to establish a new connection for each request. Any protocol allowing communication of electronic devices over distance can be used for the client-server communication of the game-playing system. In some embodiments, communication occurs via TCP/IP, connecting on a specific port, and using a long-lived socket connection between the client and the server with the data communicated is formatted as a binary stream.

In some instances, the communication of a game outcome occurs in multiple response messages. In certain of these instances, HTTP long-pulling or streaming is implemented pushing multiple sets of data in response to a single client game system request where one response may contain information related to the random symbol mapping, and another response may contain the information related to the remainder of the game outcome.

Asynchronous symbol replacement implementations tend to avoid the delays inherent in the synchronous models due, in part, to the fact that the asynchronous model provides spin event initiation generally in parallel with game outcome processing. In other words, the game client can initiate the spin event, displaying the spinning reels 610: (i) in advance of, at the time of, or after sending game initiation information, which can include a game outcome request message 615, to the central game server; but (ii) prior to receiving responsive game outcome information, e.g., 605, from the central game server.

Providing mid-spin symbol replacement 620 removes generation of the game outcome 605 as a condition of spin initiation.

In some reel game embodiments, one or more of these reel symbols (also called “placeholders” in this specification) have no graphical representation. These placeholders are replaced on a reel prior to or during a spin event by one or more of the reel symbols that do have graphical representations. In certain of these embodiments, this replacement occurs according to a random distribution for a given spin event. For example, if the name of one of the placeholders is “RAND”, and it is determined that the “RAND” placeholder will be mapped to the symbol “M1” on a given spin event, then for that spin event, every instance of “RAND” on one or more reels is replaced by “M1” in both the game logic engine on the server and in the display rendering on the client game device.

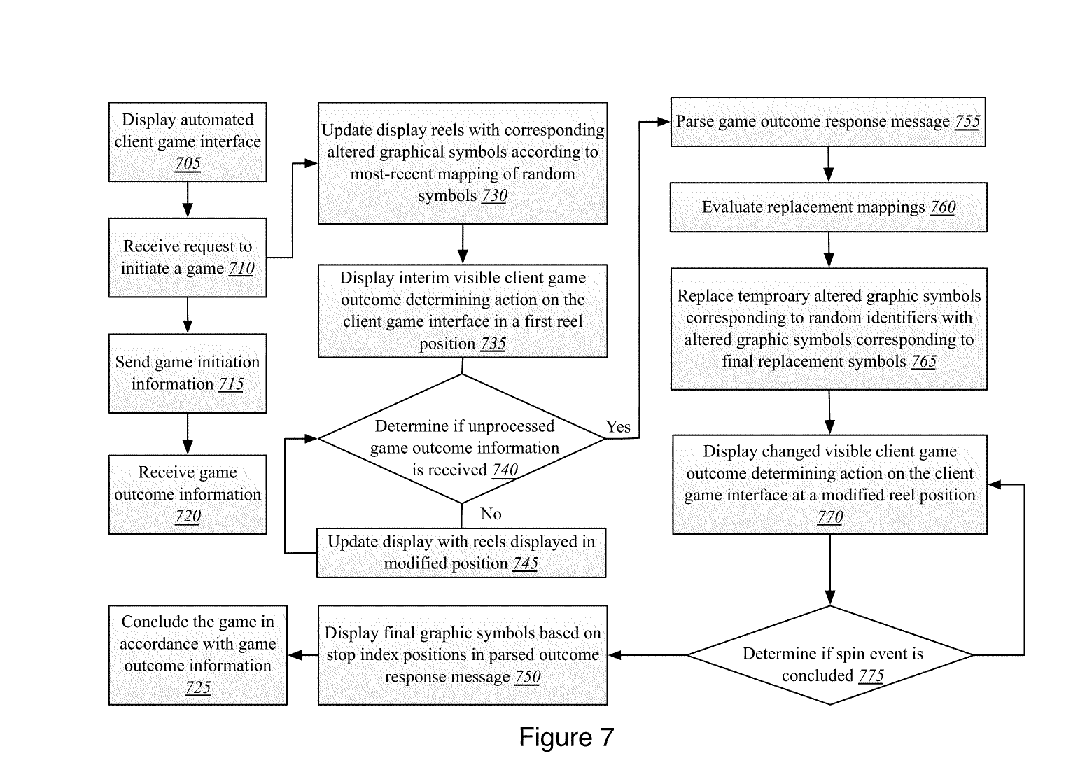

With reference now to FIG. 7, a client-side asynchronous symbol replacement process is detailed. The game client display module 365 (e.g., see FIG. 3) directs, via the display adapter 240 (e.g., see FIG. 2), to display the automated client game interface 705. This interface can include one or more user interface controls that trigger the generation of a game initiation request. Once such a request is generated by the automated client game interface 705 and received 710 by the game play engine 370, the communication module 375 sends the game initiation information 715 to the central game server 105. At some undetermined time, the game client 115 receives the game outcome information sent by the central game server 105 in response to the game initiation information sent by the game client 115.

Without regard to the sending of the game initiation information to the central game server, the game client will update the display reels with altered graphical symbols that correspond to the most-recent mapping of random symbols 730. These symbols, while altered, are recognizable with respect to the associated unaltered graphical symbol. Once at least a portion of the updates are made, the game client display module 365 (e.g., see FIG. 3) directs, via the display adapter 240 (e.g., see FIG. 2), to display interim visible client game outcome determining action on the automated client game interface 735. This display event places the reels in an initial position.

The client, while proceeding with other functions, monitors for receipt of the game outcome information 740 in response to the game initiation information sent to the central game server. If at the time of monitoring, the response has not been received, the display 235 is updated with reels displayed in modified position 745. In some embodiments, the modified position is determined based on a virtual reel spin algorithm accounting for a speed degradation curve making the virtual spin event more realistic. If instead, the response has been received, the game client initiates the process for mid-spin reel updates.

The message is delivered to the message parsing module 371 of the game playing engine (e.g., see FIG. 3), where the appropriate parsing engine parses the message 755 and obtains the values relevant to proceeding with mid-spin symbol replacement. The mapping update module evaluates the obtained replacement mappings 760 and makes the appropriate updates to the corresponding client mapping data. The reel population module 372 replaces the temporary altered graphic symbols that correspond to random identifiers with the newly-mapped altered graphic symbols corresponding to final replacement symbols 765. Once at least a portion of the replacements are made, the game client display module 365 directs, via the display adapter 240 (e.g., see FIG. 2), the display 235 to display changed visible client game outcome determining action on the automated client game interface 735. This display event places the reels in new position as part of the reel spin simulation. The display of the reels in modified positions continues until there is an indication that the spin event has concluded 775.

At the conclusion of the spin event, the game client display module 365 directs, via the display adapter 240 (e.g., see FIG. 2), the display 235 to display the final unaltered graphic symbols at their final position based on the stop index positions for the respective reels as received from the central game server in the game outcome response message. The game is the concluded and post-game activities are and functions are performed in accordance with any relevant information included in the game outcome response message 725.

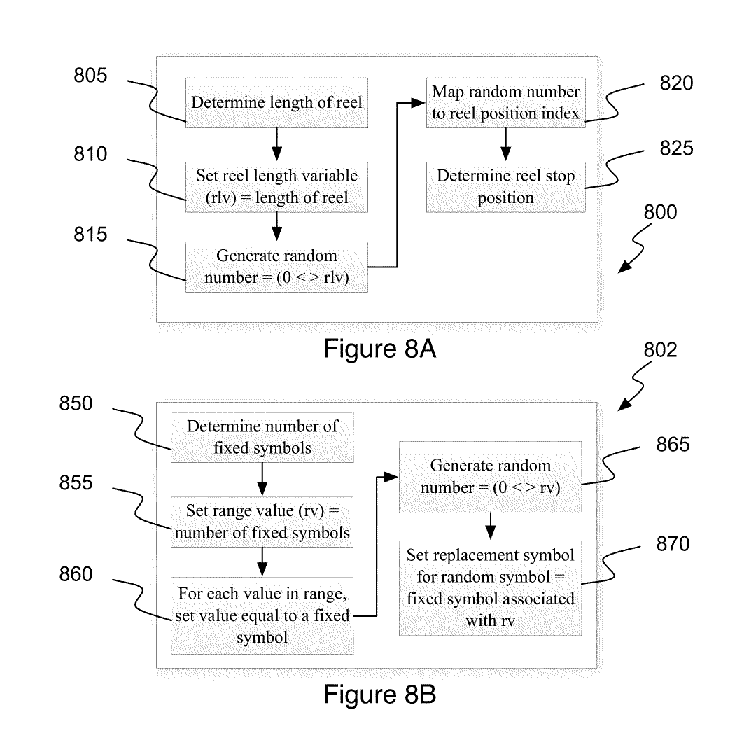

Referring now to FIG. 8A, an example of a random number generation algorithm for use by the stop position determination module 320 (e.g., see FIG. 3) as applied to reel stop position determinations is described. The length of the reel is determined 805 such that the desired range of unique identifiers for randomization is known. In some instances, the length of the reel defines a range of integers from 0 to some integer 810, 815. For example, a reel with 19 positions would define a range of integers 0 to 18. The random number generation module 345 then generates a random number from the range of the integers, mapping the number to the associated reel position index 820, and determining the reel stop position 825 as that position represented by the reel position index.

Referring now to FIG. 8B, an example of a random number generation algorithm for use by the symbol mapping module 315 (e.g., see FIG. 3) as applied mapping of random symbols is described. The number of fixed (i.e., non-random) symbols is determined 850 such that the desired range of unique identifiers for randomization is known. In some instances, the number of symbols defines a range of integers from 0 to some integer 855. For example, 8 symbols defines a range of integers 0 to 7. Each integer is then associated with a fixed symbol 860. The random generation module 345 then generates a random number from the range of the integers, and the symbol mapping module then sets the symbol replacement mapping to indicate that replacement symbol for the random symbol is now associated with the associated fixed symbol.

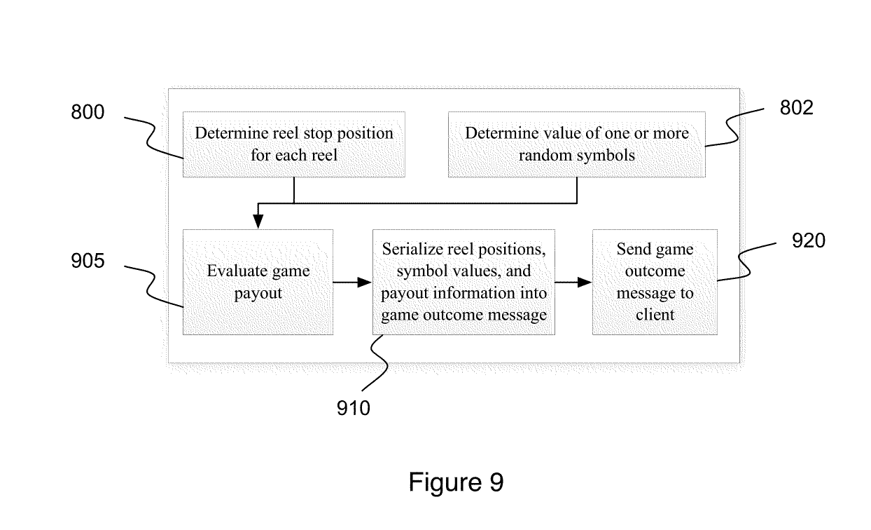

Referring now to FIG. 9, the game payout evaluation module 330 (e.g., see FIG. 3) uses the output from the stop position determination algorithm 800 and the random symbol mapping algorithm 802 to evaluate the payout. The game outcome determination engine 310 includes the payout information, along with the reel positions and symbol mapping information, in a game outcome response message 910. Once the message is prepared, the game outcome determination engine 310 passes the message to the communication module 360 for transmission to the game client 920.

In some embodiments, the context of the game may be stateless, returning to the initial game engine state before sending a response to the client, and sending a result aggregating any intermediate outcomes. In another embodiment, the asynchronous symbol replacement gaming system may be stateful, being in any of a number of intermediate states when the server sends a response to the client. In a stateful game flow, it is typically only during the initial state when a wager may be placed or changed. A pseudocode example describing the asynchronous process on the client according to some embodiments is set forth below:

/*represents an object containing the mapping of symbol definitions

(e.g. strings) to the images used to render each symbol on the reels

*/
Object GraphicalMapping {

“M1” image for “M1”,
“M2” image for “M2”, etc

}
Object RandomSymbolMapping {

“RAND1” “M1”,
“RAND2” “M2”, etc

}
//called when a spin initiation request is generated such as by, for

example, a button press that initiates the game round

function onStartButtonPressed(BetInformation betInfo) {

-send game outcome request to server
-begin spinning reels with temporary values in the

RandomSymbolMapping pending a response from the server

}
function updateReelDisplay( ) {

-move the reels down on the graphical display an amount
-render each of the symbols displayed according to the current

values in RandomSymbolMapping and GraphicalMapping

}
//Called asynchronously from onStartButtonPressed, after receiving a

response from the server

//ResponseInfo is an arbitrary type used to contain the information in

the response needed to update the reels

function onResponseObtainedFromServer(ResponseInfo
responseInfo) {

-obtain mapping for random symbols from “responseInfo”
-replace all instances of random symbols on reels with the

symbol designated for their replacement

-begin the sequence of stopping the reels according to the reel

stop positions contained in “responseInfo”

In some embodiments, the object models and functions on the client side may be arranged substantially differently than how they are represented in this pseudocode example, while still providing a mechanism for the client gaming device to store a mapping of the current values of placeholders as they are to be rendered, and updating the current values upon receiving a response from the server.

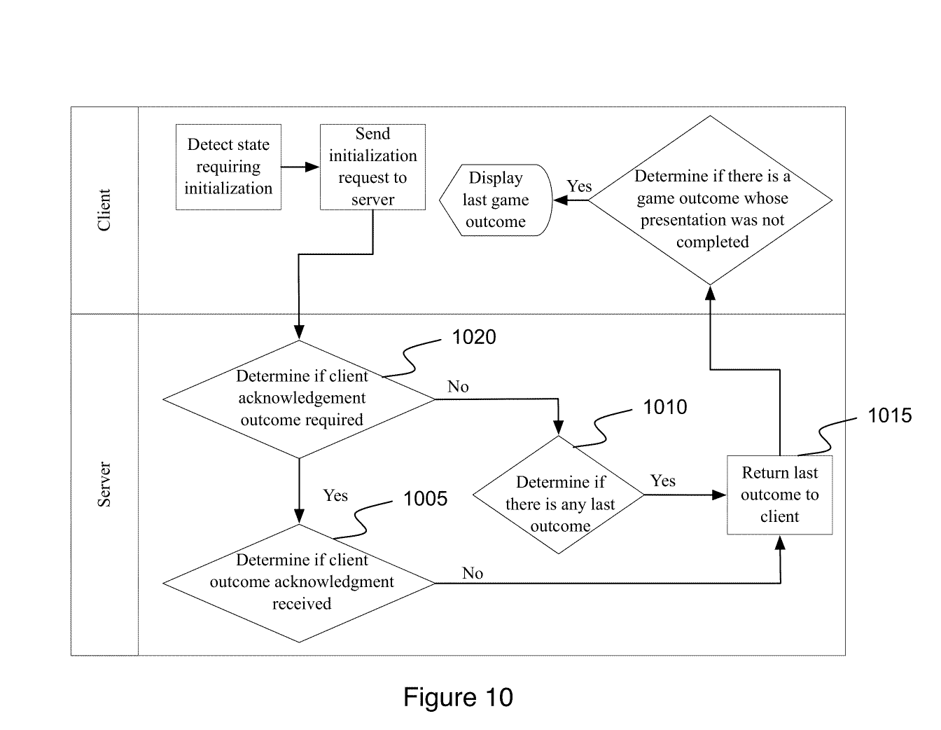

Referring now to FIG. 10, a state restoration method is described allowing the game client to recover to the last good state. In some instances, the server is configured to require an acknowledgement from the client that the last game outcome response message was applied at the game client 1005. In this type of implementation, if the acknowledgment is not received the last game outcome is sent to the game client. Alternative, where it is determined that a client acknowledgment is not required 1020, the central game server 105 determines if there is a last game outcome 1010 that can be provided to the game client 115, and if so, sends it to the game client 1015. Once received, the game client 115 determines if there is a game outcome whose presentation was not completed, which may indicate that state restoration is desired. If not complete, the last game outcome received from the central game server 1054 is displayed.

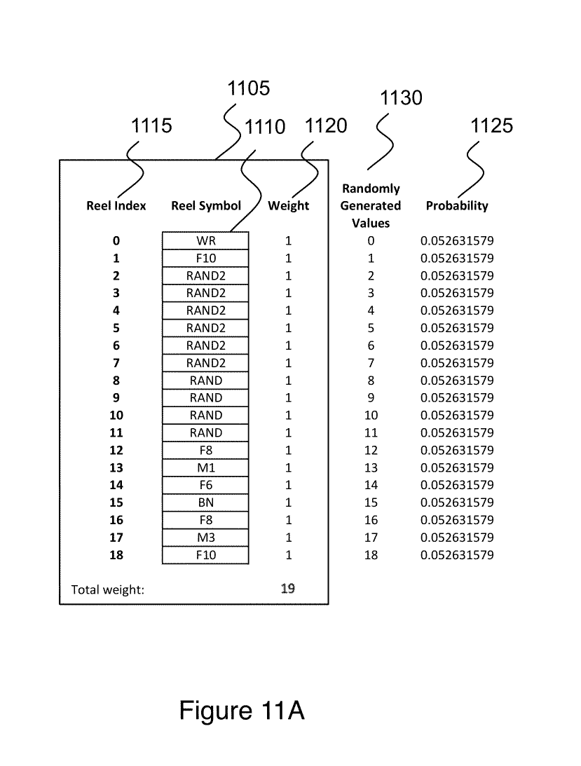

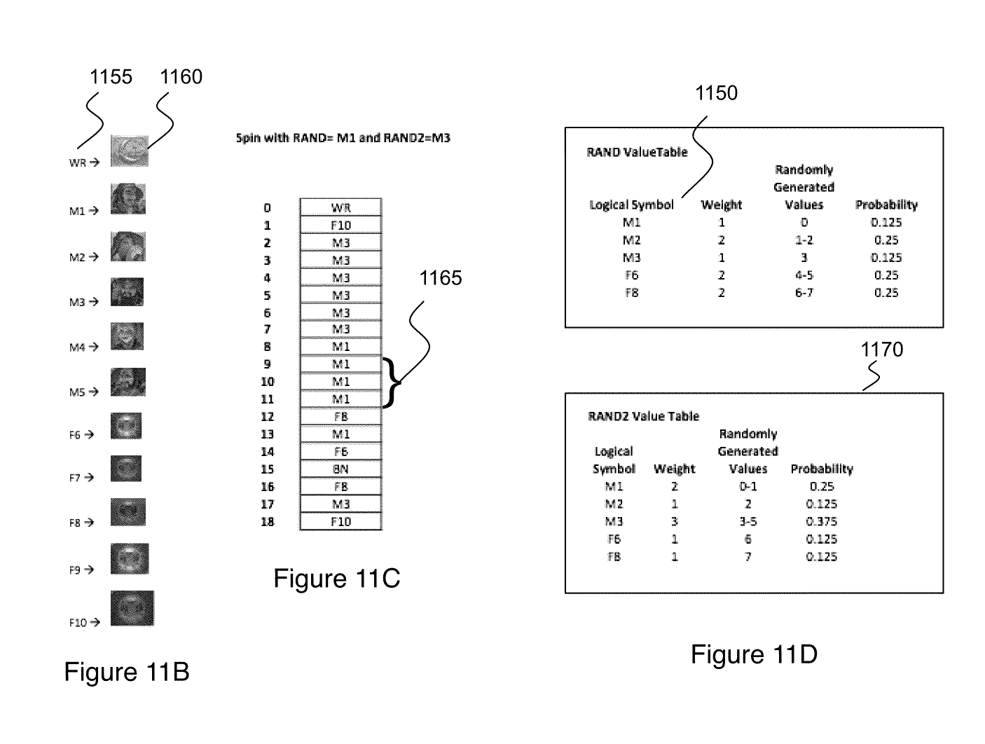

Referring now to FIG. 11A, in some reel game embodiments, one or more display reels are associated with one or more reel strips 1105. The reel strip contains one or more logical reel symbol identifiers 1110 located at certain reel indices where such indices correspond to specific positions on the reel strip. In certain of these embodiments, a reel symbol is assigned a weight 1120 that can be used as part of the game outcome calculation and relates to the probability 1125 of that symbol appearing in a game outcome. The random number generation module 625 (e.g., see FIG. 6) can generate random number according to the random number generation algorithm described in FIG. 8A. In some instances, the set of numbers used for random number generation include a set of unique integers 1130, each assigned to a single symbol reel index position. The random selection of these numbers can be used to determine the corresponding index on each reel strip that will assume the center stop position for that real as the game client display displays stopped reels.

Referring now to FIG. 11B through 11D, logical symbols on a reel can be placeholders 1150 that are not associated with graphical symbols. These placeholders can be replaced with logical symbols 1155 associated with graphical symbols 1160 according to a mapping message received from a central game server 105 (e.g., see FIG. 1). In this example, the logical symbol RAND is a placeholder that can be replaced with a logical symbol referencing a graphical symbol. In this example, the random number generator on the central game server 105 generates a 0 value, which determines that RAND will be mapped to the logical symbol M1. The central game server 105 sends a game outcome response message to a game client 115 that includes a symbol replacement mapping directing the game client 115 to replace instances of the RAND placeholder with the M1 logical symbol during a spin event. Similarly, in this example, the logical symbol RAND2 is a placeholder that can be replaced with a logical symbol 1155 referencing a graphical symbol 1160. In this example, the random number generation module 345 (e.g., see FIG. 3) in the game logic engine 305 of the central game server 105 generates a value 4, which, based on the logic of the example RAND2 value table 1170, determines that RAND2 will be mapped to the logical symbol M3. The central game server 105 sends a game outcome response message to a game client 115 that includes a symbol replacement mapping directing the game client 115 to replace instances of the RAND2 placeholder with the M3 logical symbol during a spin event. As an example of game outcome determination, the random number generation module 345 may generate a value of 10 that, in this case, corresponds to a reel index value of 10. Assuming the instant game displays three adjacent graphical representations at any given time, the game client display module 365 displays the graphic symbols associated with the logical values at reel locations 9, 10 and 11, in this case, M1, M1, and M1 1165.

Referring now to FIG. 12, an alternate asynchronous reel display embodiment includes multiple varied reel sets where a sample element of the game outcome response XML may be:

<ReelSetUsed name=“Reel v1”/>

In this alternate embodiment, the game client 115 (e.g., see FIG. 1) recognizes the availability of multiple possible reel set layouts for one or more reel strips. In certain instances of this embodiment, the central game server 105 communicates a distinct definition of sets of reels to the game client 115 before or upon initialization. The central game server 105 randomly selects one of the possible reels or reel sets to use for the given spin, evaluates the game outcome using this reel set, and communicates the reels mapping or reel set used back to the game client 115 as part of the game outcome response. In some implementations, the random number generation algorithm executed by the random number generation module 345 (e.g., see FIG. 3) generates the random number based, at least in part, on a probability calculation that accounts for individual reel weighting factors such as those that may be included in a weighting table 1210.

In some instances of the alternate embodiment of FIG. 12, the central game server 105 randomly selects each reel in the set of reels and communicates the selections to the client where, for example, on a set of 5 reels, reel 1 is selected independently of reel 2, reel 3, reel 4, and reel 5. In another instance of this alternative embodiment, sets of all reels may be selected in conjunction with one another.

Referring now to FIG. 13, in another asynchronous reel display embodiment, a single reel set is recognized by both the game client 115 and the central game server 105 (e.g., see FIG. 1) prior to game initiation. For each spin, a set of reel index positions is selected for one or more reels with symbols to replace logical symbols and placeholders at those indices. In some instances of this embodiment, a sample response communicating the symbols and overlays for each reel can be structured as follows:

<Overlays>

<OverlayReel reel=“reel1” beginIndex=“4” endIndex=“9”
symbol=“M1”/>
<OverlayReel reel=“reel1” beginIndex=“10” endIndex=“13”
symbol=“M2”/>

</Overlays>

In this example, natural reel definition 1305 corresponds to the initial displayed reel layout prior to the initiation of the spin event. The random number generation module 345 (e.g., see FIG. 3) of the central game server 105 generates a random number, in this example, the value of 1, corresponding to a configuration number representative of one or more distinct reel portion overlays 1315. In some implementations, the random number generation algorithm executed by the random number generation module 345 generates the random number based, at least in part, on a probability calculation that accounts for individual configuration weighting factors such as those that may be included in a weighting table 1320. Continuing with this example, the random number selection corresponds to configuration 1, indicating a replacement specific symbol overlay resulting in the reel strip layout indicated at 1310.

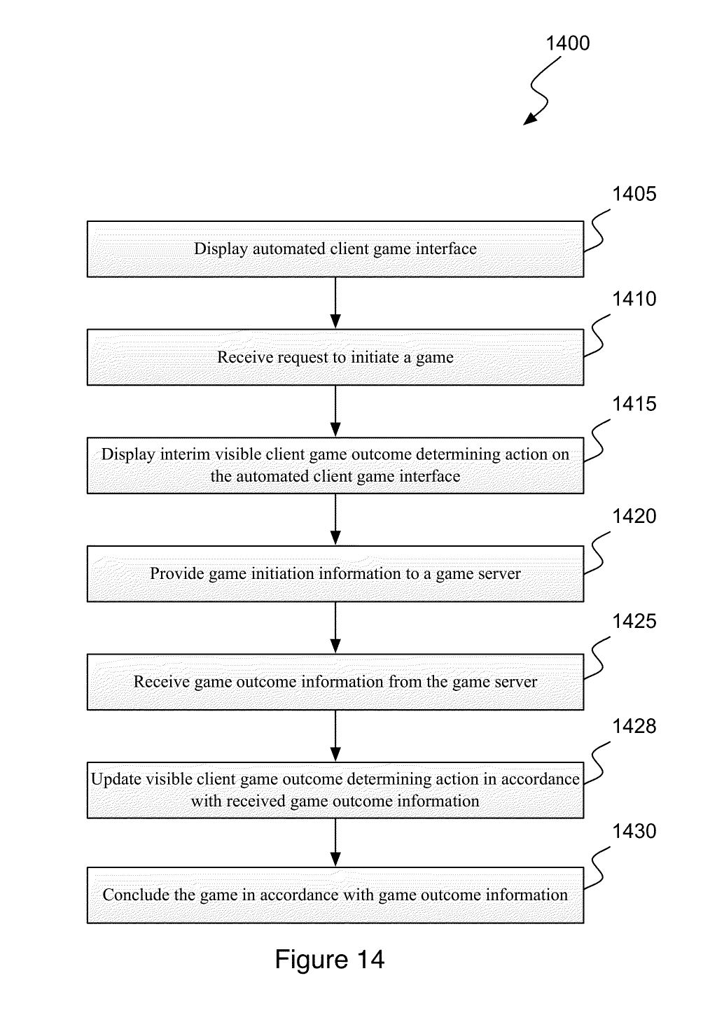

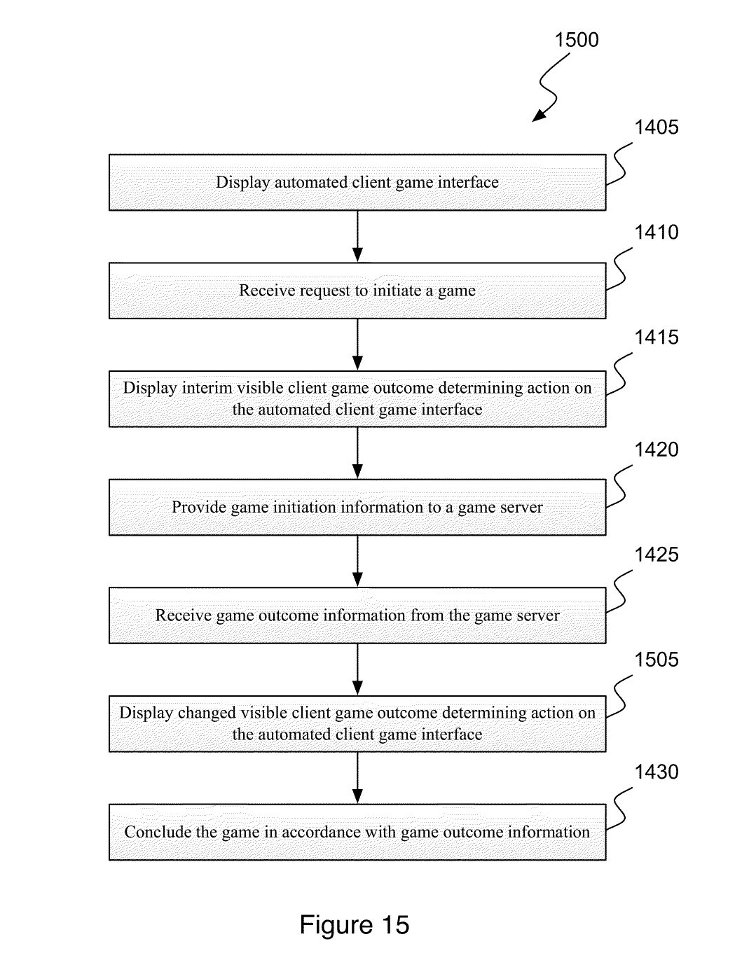

Referring now to FIG. 14 and FIG. 15, methods 1400 and 1500 that may be carried out by a game playing client system implementing asynchronous game playing action are described according to various embodiments. The methods 1400 and 1500 can, for example, be performed by the game playing system of FIG. 1, 2, 3, or 6, or using any combination of the devices described for these figures.

Initially, at block 1405 the game client display module 365 (e.g., see FIG. 3) directs, via the display adapter 240 (e.g., see FIG. 2), to display the automated client game interface. At block 1410, the game client 115 (e.g., see FIG. 1) receives a game initiation request in response to, for example, detection of a spin control button selection event for a button displayed as part of the automated client game interface. At block 1415, the game client displays interim visible client game outcome determining action. In some embodiments, display of the interim visible client game outcome determining action occurs prior to sending game outcome information, which can include a game outcome request, to a central game server 105. At block 1420, the game client 115 provides game initiation information to a central game server 105. In some instances, the game client 115 makes a REST based call to the central game server 105 over HTTP or HTTPS using a pre-defined URL. At block 1425, the game client 115 receives the game outcome information from the central game server, and at block 1428, updates the visible client game outcome determining action in accordance with the received game outcome information.

For example, during the spin event, temporary placeholders can be replaced with corresponding altered graphical replacement symbols corresponding to final non-altered replacement symbols. At block 1505, the game play engine, in combination with the display module, displays the changed client game outcome determining action as updated by the mapping update module 374. In some instances, the altered graphical replacement symbols retain a recognizable relation corresponding to the non-altered graphical replacement symbol. The game client concludes the game and performs or initiates post-game activities and functions in accordance with any relevant game outcome information included in the game outcome response message.

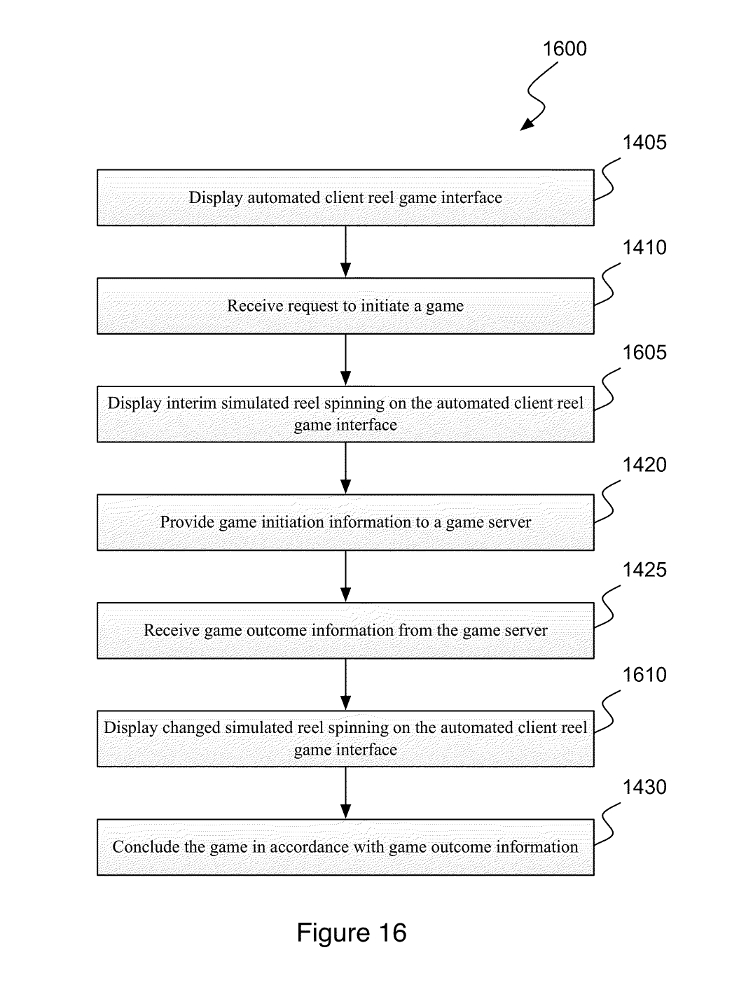

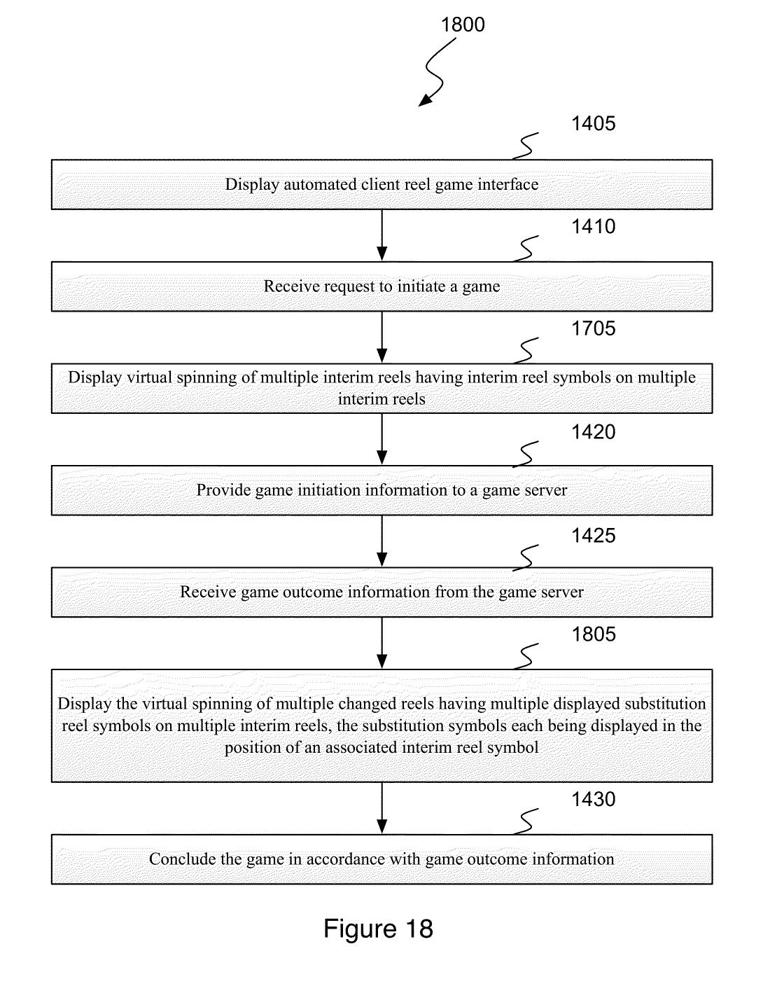

Referring now to FIG. 16 through FIG. 18, methods 1600, 1700, and 1800 that may be carried out by a game playing client system implementing asynchronous game playing action for a simulated reel game, are described according to various embodiments. These methods can, for example, be performed by the game playing system of FIG. 1, 2, 3, or 6, or using any combination of the devices described for these figures. At block 1605, the display module 365 of the game client 115 displays interim simulated reel spinning on the automated client reel game interface, and at block 1620, displays changed simulated reel spinning on the automated client reel game interface.

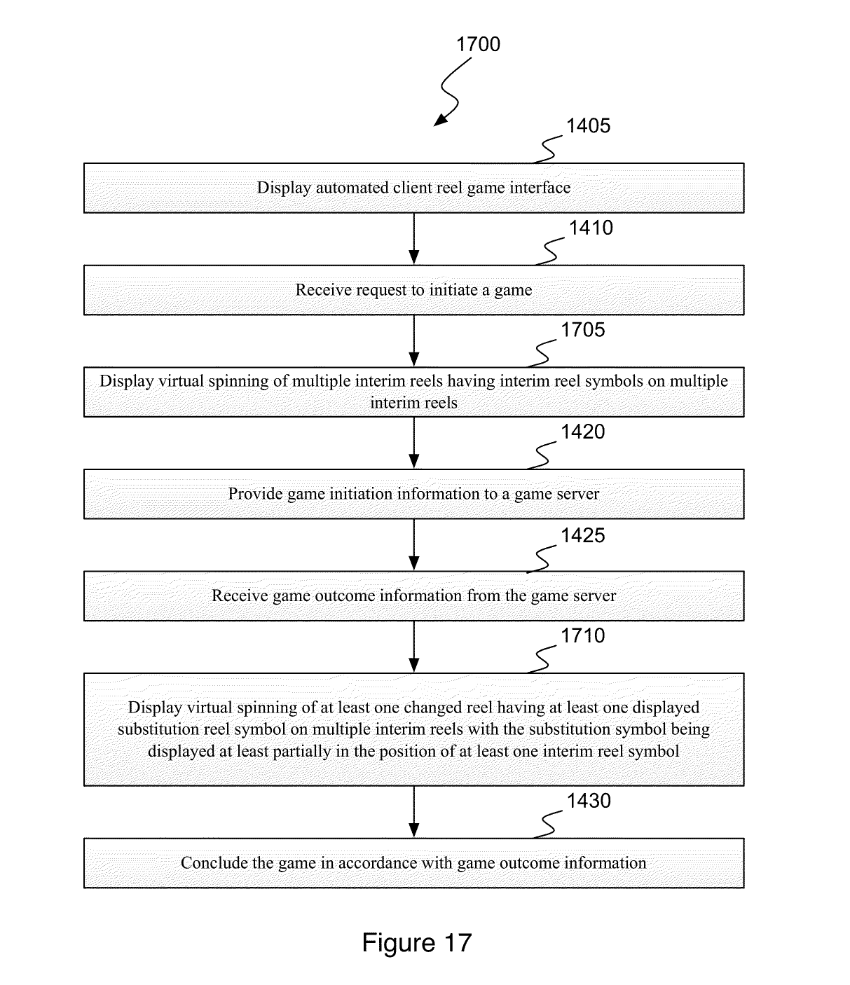

Referring now to FIG. 17, at block 1705, the display module 365 of the game client 115 displays virtual spinning of multiple interim reels having interim reel symbols on multiple interim reels, and at block 1710, displays virtual spinning of at least one changed reel with at least one substitution reel symbol on multiple interim reels with the substitution symbol displayed in part, or in full, in the position of at least one interim reel symbol. In some embodiments, at block 1805 the display module 365 of the game client 115 displays virtual spinning multiple changed reels with multiple substitution reel symbols on multiple interim reels with the substitution symbols each displayed in the position of an associated interim reel symbol.

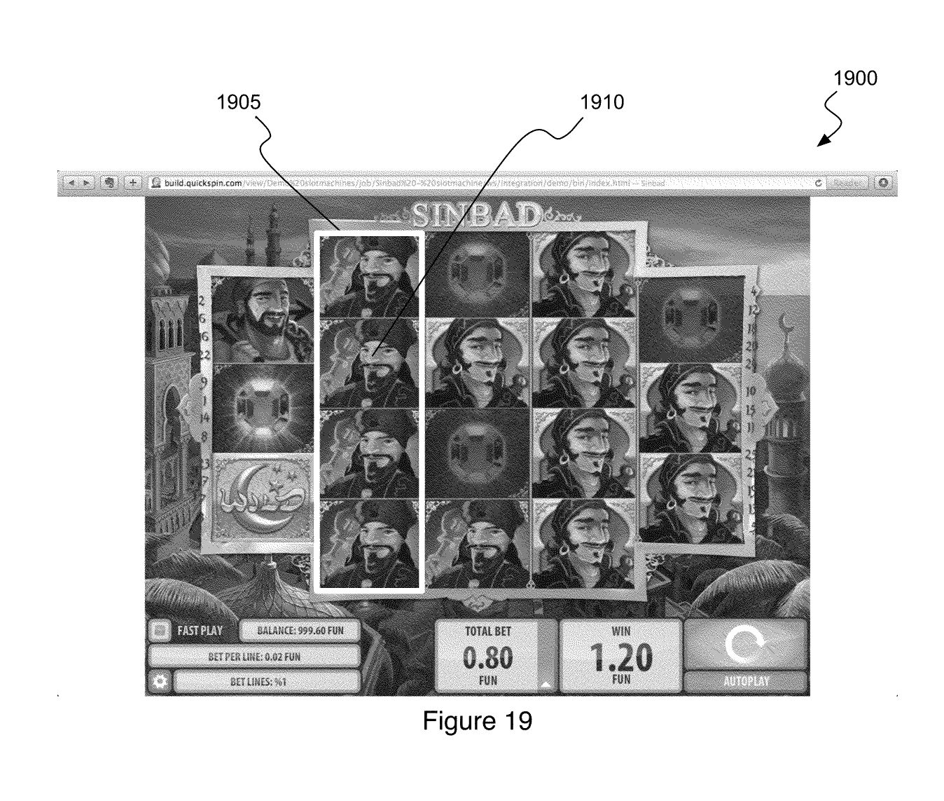

Referring now to FIG. 19, a gaming device display displays 235, 240 (e.g., see FIG. 2) a waiting state game instance 1900 representing multiple simulated reels in which a first spin event is complete and a second spin event request has not been generated. In this example, reel two 1900 includes multiple graphical representations of associated logical symbols. One of these graphical representation is an animated character 1910, which is the graphical representation associated with the logical symbol mapping for a placeholder. The central game server, the game client, or both can determine the association of the graphical representation to the logical symbol.

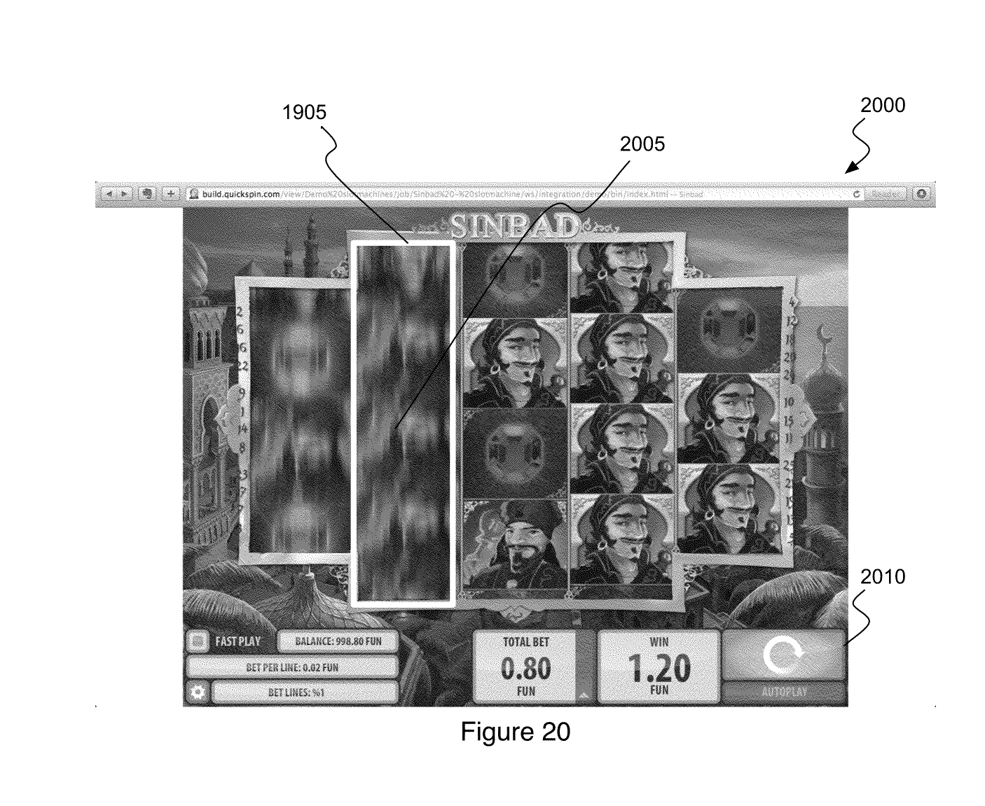

Referring now to FIG. 20, the game client 115 (e.g., see FIG. 1) receives a game initiation request in response to, for example, detection of a spin control button 2010 selection event and sends game outcome information, which can include a game outcome request, to a central game server 105. The game client 115 initiates a spin event prior to receiving a game outcome response from the central game server 105, which response can include a symbol replacement mapping. In some embodiments, the game client 115 initiates reel spin events for each reel spin in an asynchronous manner. In this example, clear graphical representations 1910 are replaced with corresponding altered graphical representation 2005 as a part of the spin display event. In some instances, the altered graphical representation retains a recognizable relation corresponding to the unaltered graphical representation. Here, the animated character of the unaltered graphical representation 1910 on the second reel 1905 (e.g., see FIG. 19) is identifiable by shapes, color, or both included in the altered graphical representation 2005. In this example, the symbols in use are the same set of symbols used for the prior spin event.

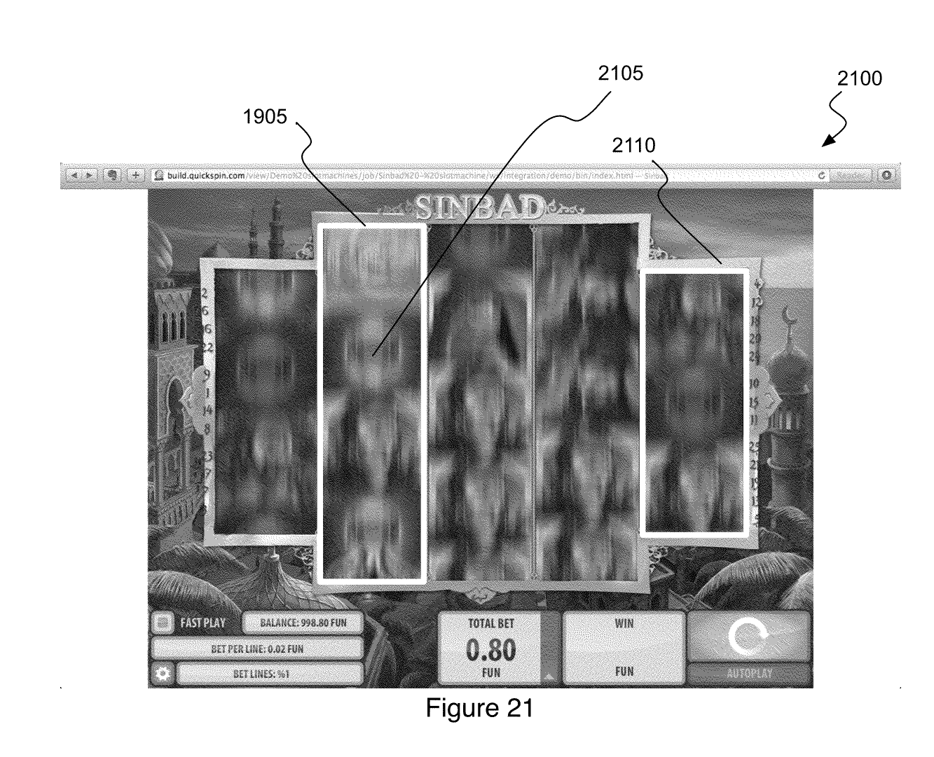

With reference now to FIG. 21, the game device display of FIG. 19 continues to display a spin event for reel 2 1905 while additional spin initiation occurs for other reels 2110. In this example, the gaming clients 115, temporarily includes a graphical representation of an altered animated jewel 2105 included from the prior spin event (not shown) in the current spin event. At this point, a game outcome response and symbol mapping has not yet been received from the game server.

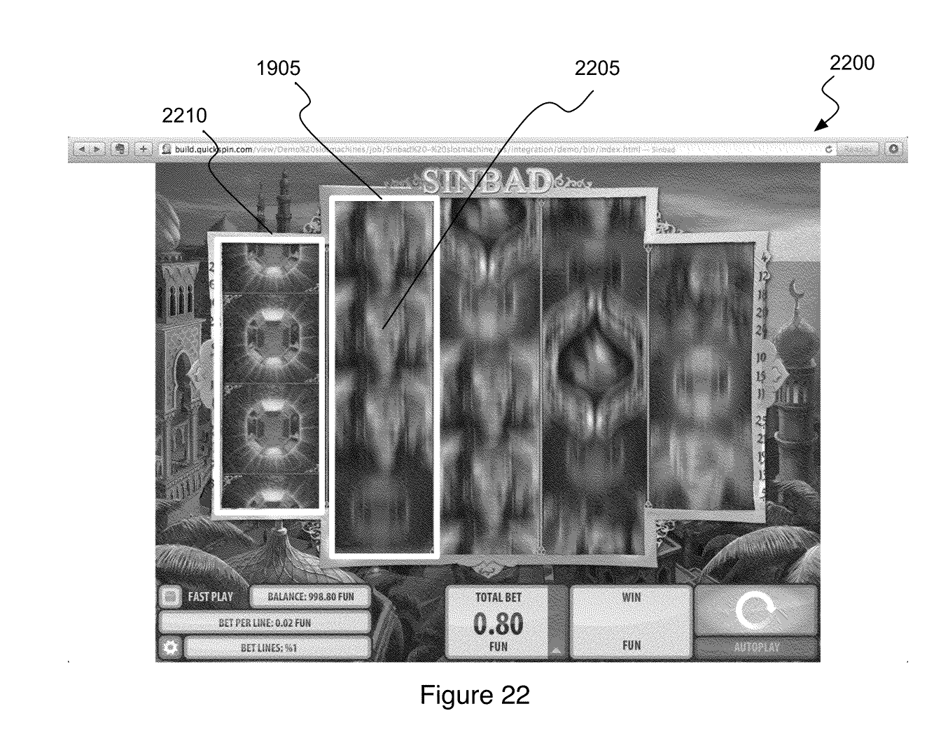

Referring next to FIG. 22, in this example, the game client 115 (e.g., see FIG. 1) receives the game outcome response including a symbol replacement mapping and respective reel stop index positions, from the central game server 105, and seamlessly replaces one or more symbols during the spin event for one or more reels based on the symbol replacement mapping received. Reel one 2210 is slowing and is approaching its stop position based on the stop index received in the game outcome response message. In some embodiments, the central game server communicates a random number rather than an index and the game client determines the stop index based on a predefined mapping of random numbers to reel position indices. As reel two continues to spin, the game client 115 displays replaced symbols, including a differently-colored altered graphical representation 2205 replacing the temporary graphical representation 2005 (e.g., see FIG. 20) derived from the symbol replacement mapping parsed from the received game outcome information message and the associated graphical representation.

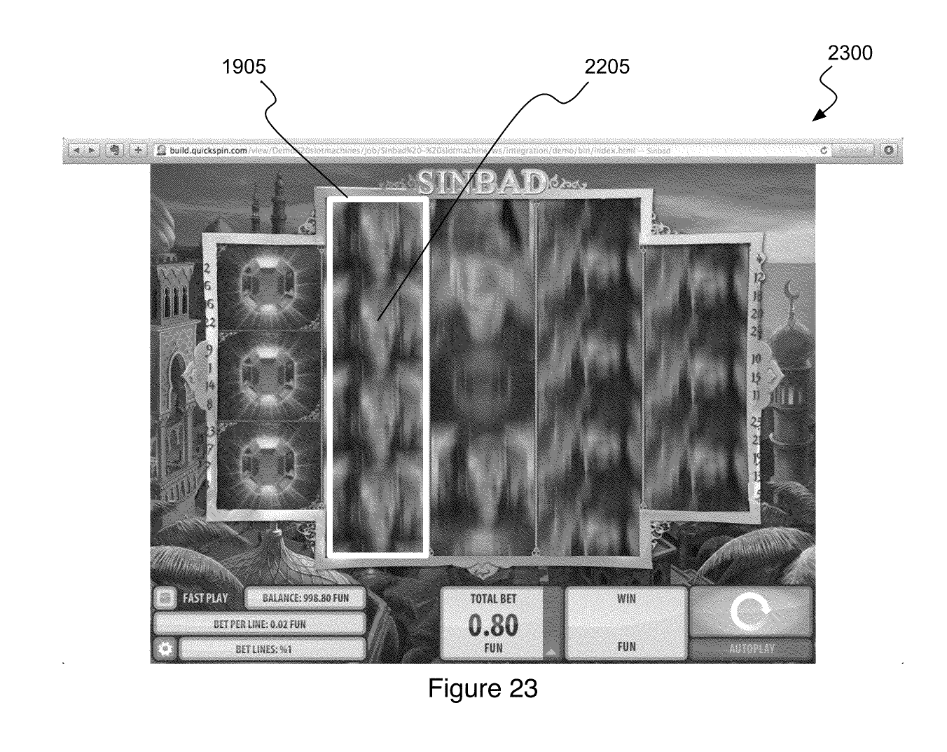

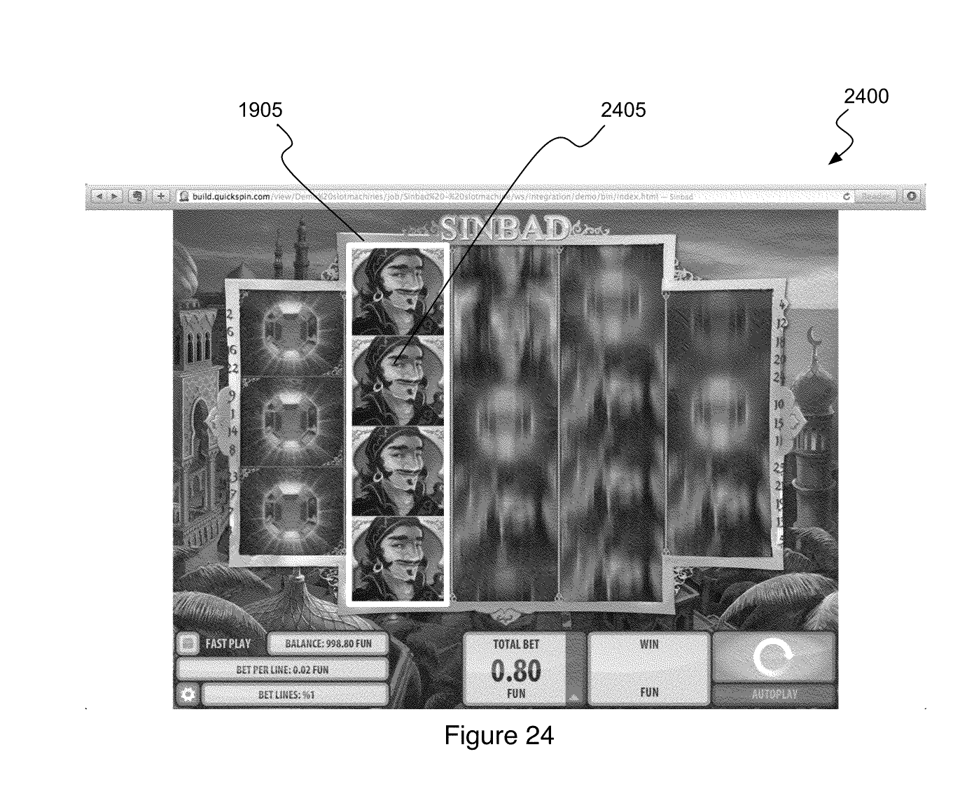

With reference now to FIG. 23, the stop position for reel two 1100 is determined and the reel is approaching that stop position. Referring to FIG. 16, the spin event for reel two 1100 concludes and the game client display of FIG. 2 displays the final graphical representations for the spin event based, at least in part, on the stop index received from the central game server 105 (e.g., see FIG. 1). In this example, the placeholder symbol that was previously mapped to one graphical representation of an animated character 1910 is now mapped to a different graphical representation of a different animated character 2405.

In some embodiments, the game client sends game initiation information, including a game outcome request, to a central game server in response to a spin initiation request. This game outcome request can be, for example, a REST based call to a server over HTTP or HTTPS using a pre-defined URL. Some implementations use the HTTP POST method. Additionally, and alternatively, the message is sent using GET methods and similar parameters, or using a non-HTTP protocol. In some instances the game client 115 (e.g., see FIG. 1), game state, and session is uniquely identified by a single sessionid variable stored in a single cookie, or by other identification mechanisms such as, for example, separate cookies or a unique identifier based on the IP address of the game client 115. Parameters can include, for example, “betlines” which corresponds to the number of lines configured to play by the client, and “coinvalue” which corresponds to the amount bet on each payline. In some embodiments, the game client 115 passes these parameters as arguments that are included in a portion of the URL and that appear in a format such as betlines=30&coinvalue=0.05.

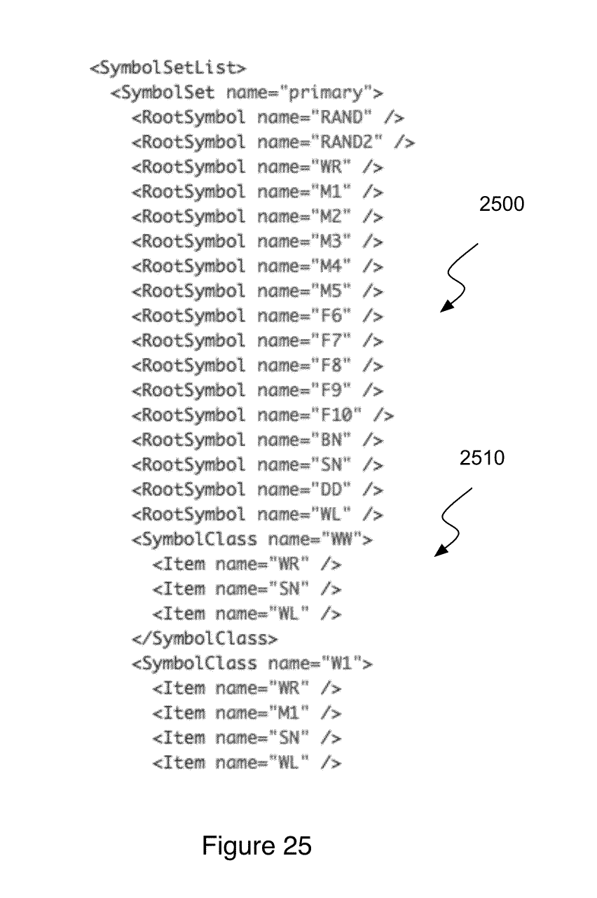

In some embodiments, messages communicated between game clients 115 and central game servers 105 (e.g., see FIG. 1) are represented in human-readable XML format. In other embodiments, implementations of the gaming system 100 use other message formats such as, for example, JSON, compressed text, encrypted text, and/or binary data objects. Referring now to FIG. 25, an example excerpt from a reel strip configuration represented in XML format for the SymbolSet element is shown. In some embodiments a list of the various symbol IDs such as, for example, RAND, WR and BN are associated with the name associated with the RootSymbol element through name:value pairings 2500. In certain instances, the reel strip configuration may contain substitution mappings for logical symbols 2510.

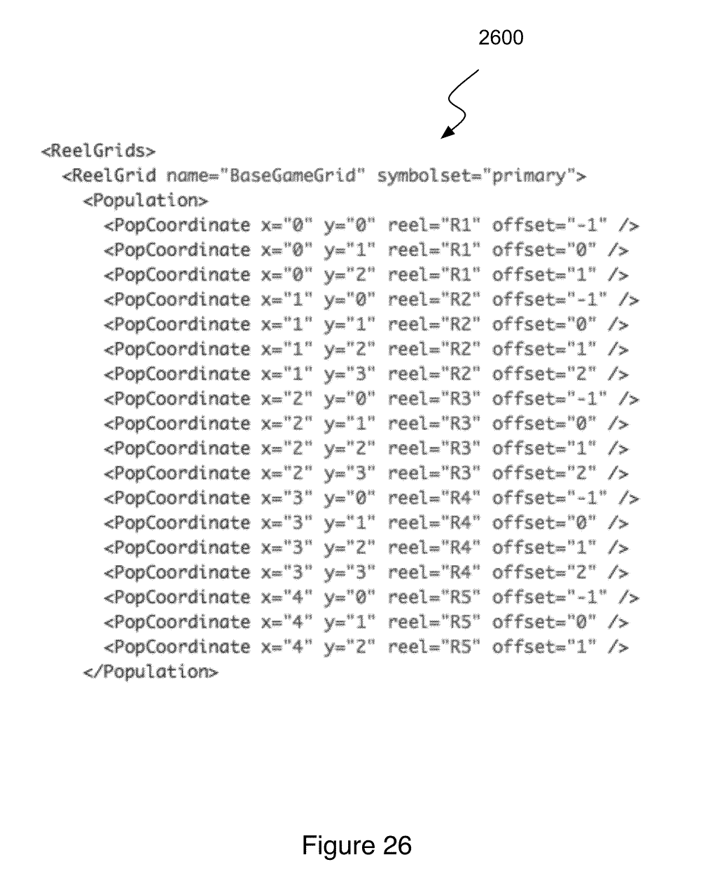

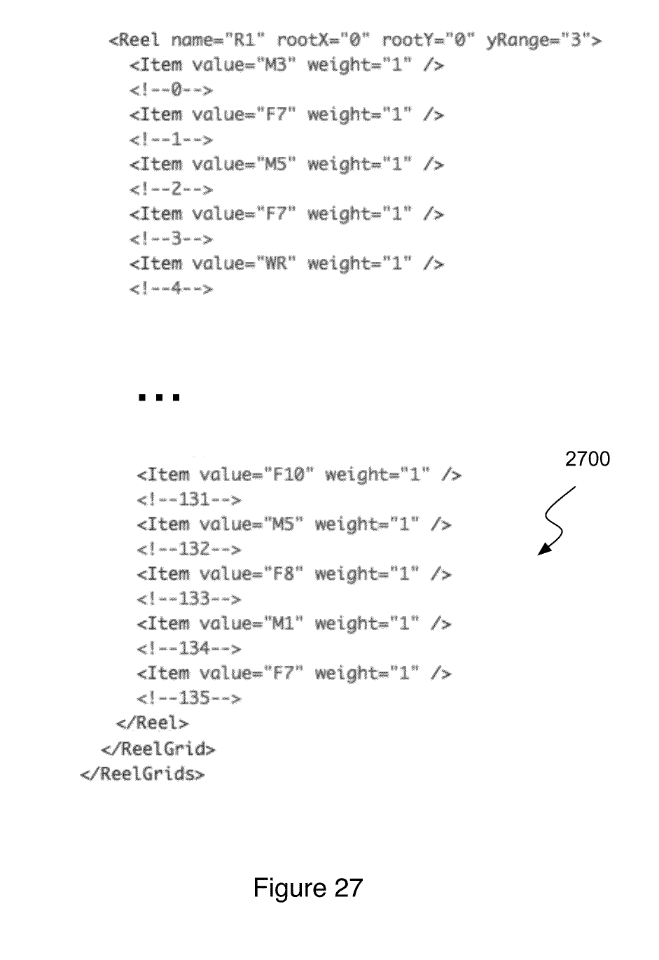

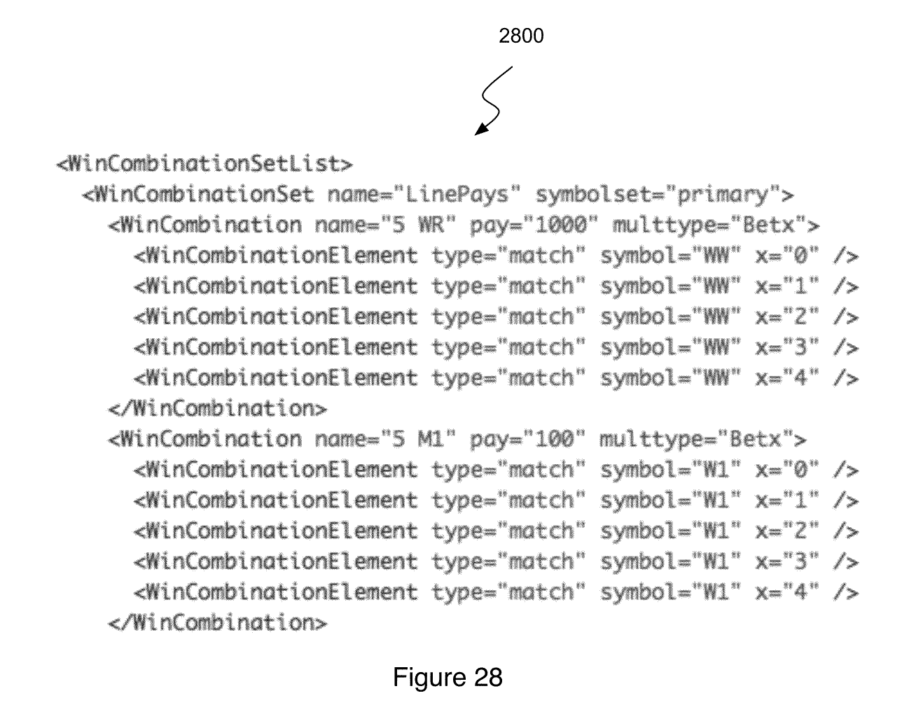

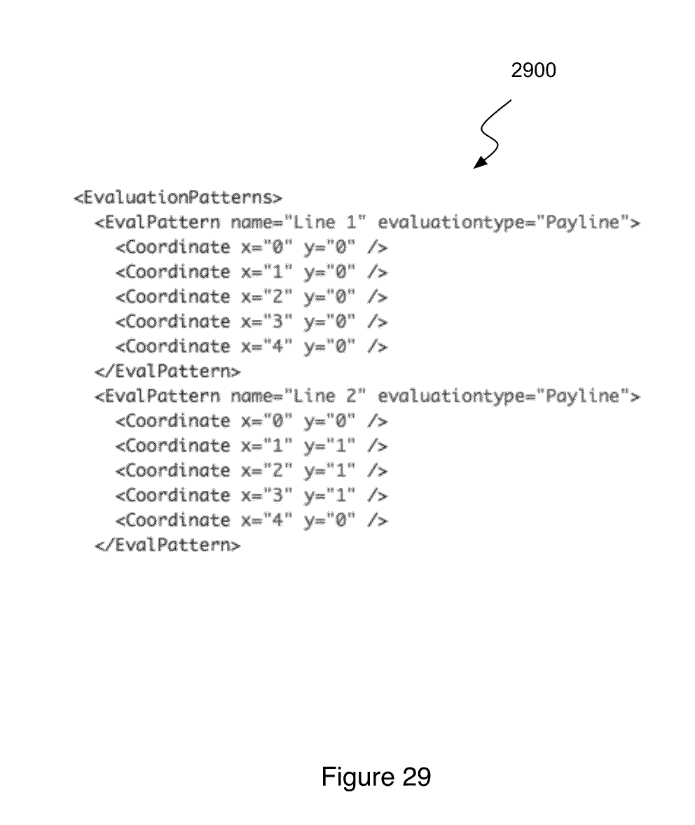

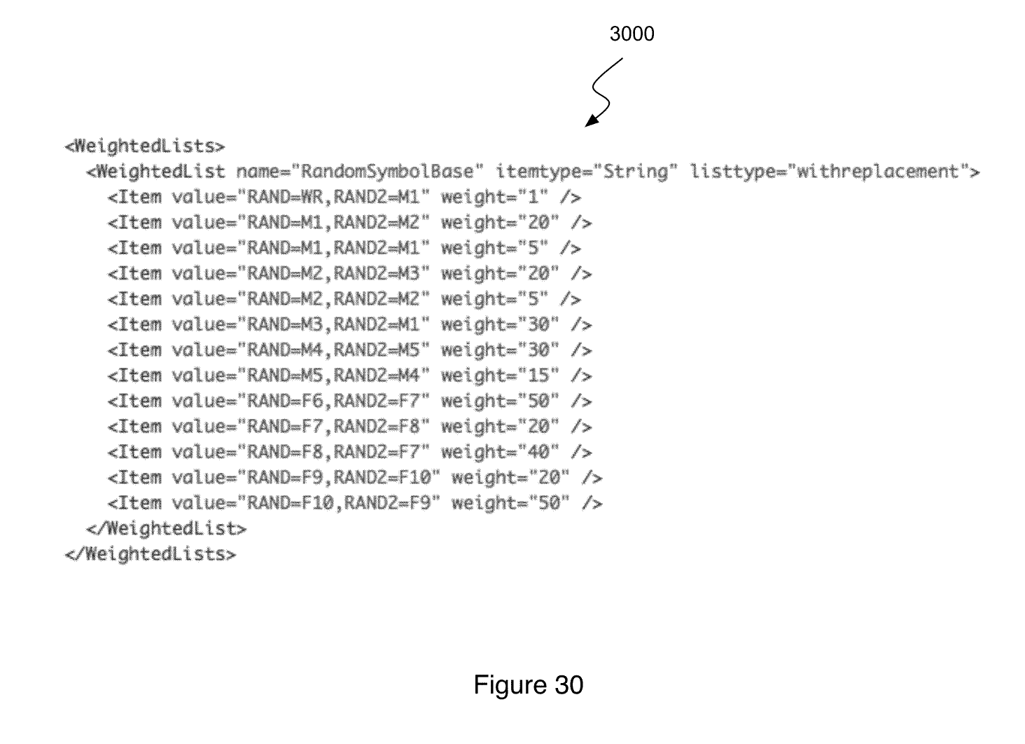

Referring now to FIG. 26 and FIG. 27, in some instances, the reel strip configuration provides mapping of reel grid coordinates to reel positions and definitions of reel strips 2600, and contains an ordered list for one or more reel strips 2700. With reference to FIG. 28, the reel strip configuration can also include one or more groupings of win combinations of logical symbols 2800. The configuration can further include other attribute information relating to the win combination including, for example, pay information and/or type information. Referring now to FIG. 29 and FIG. 30, some instances of the reel strip configuration define the reel grid coordinates used for evaluation for each payline/scatter evaluation group 2900, and provide a weighted list of logical symbols as mapped to the placeholders 3000. In some embodiments, a “RandomSymbolBase” element provides the random weightings used to derive probabilities for each configuration of random symbols. In certain of these instances, there can be multiple separate weighted lists for different states.

In addition to reel strip configuration, in some embodiments, a central game server 105 (e.g., see FIG. 1) generates a game outcome response and sends the response to the game client 115. Generally, the game outcome response can contain win information, information about a player's balance at the completion of the spin event, other information about the game state at the completion of the spin event, information that may be relevant to the game state in anticipation of a subsequent spin event, and the like. The game outcome response can also contain a description of the position indices indicating to the client game device where to stop the reels and a mapping of one or more placeholders to associated logical symbols. In some instances a GameState element contains information about the game state at the completion of the spin event, a LastPlacedBet element containing information relating to the last bet placed prior to the generation of the current response, and/or symbol mappings for one or more placeholders 3100. In some embodiments, the game outcome response includes the randomly generated results that indicate the stop positions for each reel 3105.

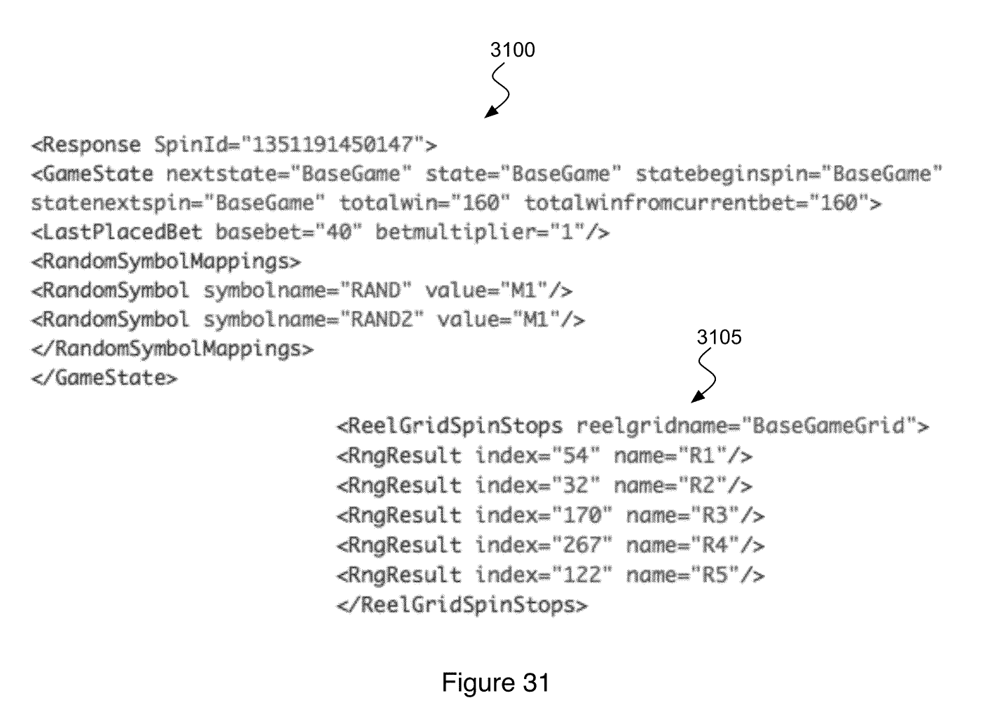

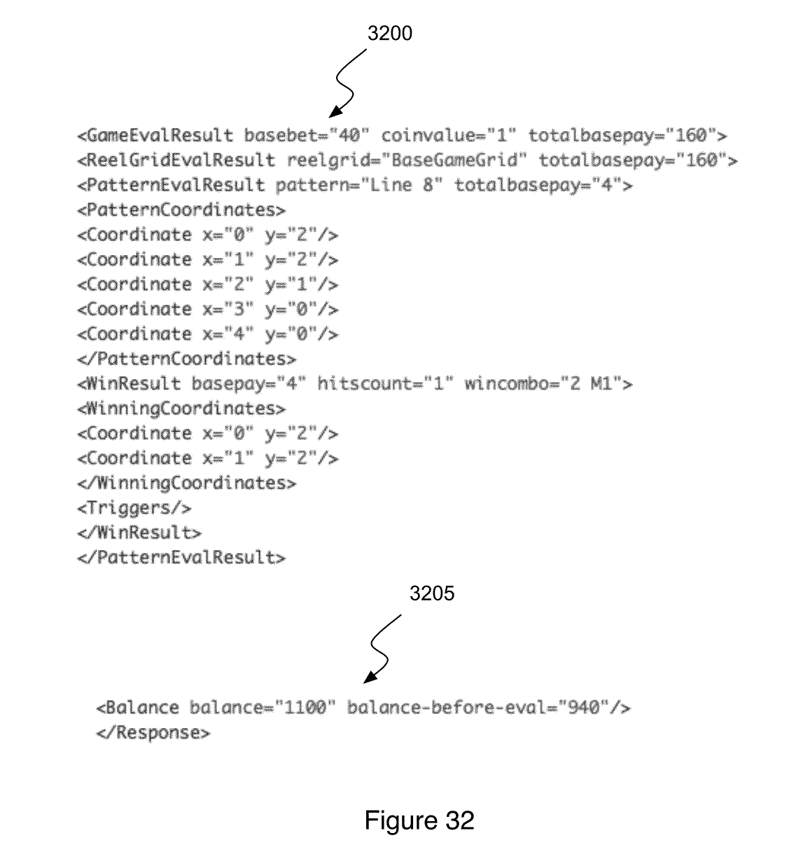

In certain instances, the game outcome response includes a summary of the game result including information such as, for example, wins and bonus triggers. With reference now to FIG. 31, a ReelGridEvalResult element can include a summary of the game result for the paylines/scatter areas for one or more reel grids. PatternEvalResult elements can each contain a summary of the win outcome for each payline, including the reel grid coordinates of the win, the name of the winning combination, and/or the payout 3200. Non-winning paylines may not have PatternEvalResult elements in the XML response. In some embodiments, the game outcome response can include a player's account balance before the spin event commences, after the spin event completes, or both 3105.

It is to be understood that asynchronous client-server event initiation and indicia replacement systems and method can be utilized with games other than those including one or more reels. For example, these techniques can be used in a game that displays only a portion of a spinning wheel. They can be used in any type of game where (i) local game action is at least partly subject to delay for procurement of a response from the server and (ii) indicia replacement in the action as a result of the response can take place after locally commencing the action. The action may constitute any type of local activity, including without limitation physical movement, sound, messaging, or simulation of any such physical activity.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures may be implemented to achieve the same functionality.

The process parameters and sequence of steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, the functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present systems and methods and their practical applications, to thereby enable others skilled in the art to best utilize the present systems and methods and various embodiments with various modifications as may be suited to the particular use contemplated.

Unless otherwise noted, the terms “a” or “an,” as used in the specification and claims, are to be construed as meaning “at least one of” In addition, for ease of use, the words “including” and “having,” as used in the specification and claims, are interchangeable with and have the same meaning as the word “comprising.” In addition, the term “based on” as used in the specification and the claims is to be construed as meaning “based at least upon.” Also, the term “immediately” with respect to a delay of machine action means without delay typically perceivable by human users.

We claim:

1. A method of playing a game provided by a client-server system, the client-server game playing method comprising:
displaying an automated client game interface for a client system;
receiving a request to initiate a client game on the client system;
after receiving the request to initiate the client game on the client system:
displaying interim visible client game outcome determining action on the automated client game interface, and providing game initiation information toward the game server system;
while displaying the interim visible client game outcome determining action on the client game interface: receiving game outcome information from the game server system and providing changed visible client game outcome determining action on the client game interface; and
concluding the game on the client system in accordance with game outcome information and the changed visible client game outcome determining action.

2. The client-server system game playing method of claim 1 the step of displaying the automated client game interface for the client system includes doing so in response to receipt of client game interface operating information from the game server system.

3. The client-server game playing method of claim 1 wherein the game is a virtual slot machine game game, the automated client game interface is an automated client virtual slot machine interface, and the interim visible client game outcome determining action includes interim simulated slot machine action.

4. The client-server game playing method of claim 1 wherein the game is a reel game, the automated client game interface is an automated client reel game interface, and the interim visible client game outcome determining action includes interim simulated reel spinning.

5. The client-server game playing method of claim 2 wherein the client game is a reel game, the automated client game interface is an automated client reel game interface, the interim visible client game outcome determining action includes interim simulated reel spinning and the changed visible client game outcome determining action includes changed simulated reel spinning

6. The client-server game playing method of claim 5 wherein (i) the interim simulated reel spinning includes displaying in the automated client game interface virtual spinning of a plurality of interim reels having interim reel symbols on the plurality of interim reels and (ii) the changed simulated reel spinning includes displaying in the automated client game interface virtual spinning of at least one changed reel having at least one displayed substitution reel symbol on the plurality of interim reels, said substitution symbol being displayed at least partially in the position of at least one interim reel symbol.

7. The client-server game playing method of claim 5 wherein (i) the interim simulated reel spinning includes displaying in the automated client game interface virtual spinning of a plurality of interim reels having interim reel symbols on the plurality of interim reels and (ii) the changed simulated reel spinning includes displaying in the automated client game interface virtual spinning of a plurality of changed reels having at a plurality of displayed substitution reel symbols on the plurality of interim reels, said substitution symbols each being displayed in the position of an associated interim reel symbol.

8. The client-server reel game playing method of claim 1 wherein steps of providing game initiation information toward the game server and receiving game outcome information from the game server system each include transmission of data through the Internet.

9. The client-server reel game playing method of claim 5 wherein steps of providing reel game initiation information toward the game server and receiving reel game outcome information from the game server system each include transmission through the Internet.

10. The client-server game playing method of claim 5 wherein the step of displaying interim visible client game outcome determining action on the automated client game interface commences within less than 200 milliseconds after the step of receiving the request to initiate the client game on the client system.

11. A method of playing a reel game provided by a client-server reel game system, the client-server reel game playing method comprising:
displaying an automated client reel game interface on a client system;
receiving a request to initiate a client reel game on the client system;
after receiving the request to initiate the client reel game on the client system:
displaying on the automated client reel game interface interim reel spinning with interim reel indicia, and providing reel game initiation information toward a game server system;
while displaying the interim reel spinning indicia with the interim spinning reel indicia on the automated client reel game interface, receiving reel game outcome information from the game server system;
displaying on the automated client reel game interface substituted reel spinning including substituted reel indicia in accordance with the reel game outcome information; and
concluding the reel game on the client system accordance with the reel game outcome information and the substituted reel spinning indicia for the automated client reel game interface.

12. The client-server reel game playing method of claim 11 wherein steps of providing reel game initiation information toward the game server and receiving reel game outcome information from the game server system each include transmission through the Internet.

13. The client-server reel game playing method of claim 11 wherein (i) the interim simulated reel spinning includes displaying in the automated client reel game interface virtual spinning of a plurality of interim reels having interim reel symbols on the plurality of interim reels and (ii) the substituted reel spinning includes displaying in the automated client game interface virtual spinning at least one changed reel having at least one substitution reel symbol on the plurality of interim reels, said substitution symbol being displayed at least partially in the position of at least one interim reel symbol.

14. The client-server reel game playing method of claim 11 wherein (i) the interim simulated reel spinning includes displaying in the automated client game interface virtual spinning of a plurality of interim reels having interim reel symbols on the plurality of interim reels and (ii) the substituted reel spinning includes displaying in the automated client game interface virtual spinning of a plurality of changed reels having a plurality of displayed substitution reel symbols on the plurality of changed reels, each of said substitution symbols each being displayed in the position of an associated interim reel symbol.

15. The client-server reel game playing method of claim 13 wherein steps of providing reel game initiation information toward the game server and receiving reel game outcome information from the game server system each include transmission through the Internet.

16. The client-server reel game playing method of claim 14 wherein steps of providing reel game initiation information toward the game server and receiving reel game outcome information from the game server system each include transmission through the Internet.

17. The client-server game playing method of claim 11 wherein the step of displaying interim reel spinning with interim reel indicia on the automated client game interface commences immediately after the step of receiving the request to initiate the client reel game on the client system.

18. The client-server game playing method of claim 12 wherein the step of displaying interim reel spinning with interim reel indicia on the automated client game interface commences within less than 200 milliseconds after the step of receiving the request to initiate the client reel game on the client system.

19. The client-server game playing method of claim 13 wherein the step of displaying interim reel spinning with interim reel indicia on the automated client game interface commences within 200 milliseconds or less after the step of receiving the request to initiate the client reel game on the client system.

20. The client-server game playing method of claim 14 wherein the step of displaying interim reel spinning with interim reel indicia on the automated client game interface commences immediately after the step of receiving the request to initiate the client reel game on the client system.
